(19) United States
(12) Patent Application Publication
(10) Pub. No.: US 2024/0004216 A1
(43) Pub. Date: Jan. 4, 2024

(54) AIR FLOATING VIDEO DISPLAY APPARATUS AND LIGHT SOURCE APPARATUS

(71) Applicant: Maxell, Ltd., Kyoto (JP)

(72) Inventors: Koji HIRATA, Kyoto (JP); Koji FUJITA, Kyoto (JP); Toshinori SUGIYAMA, Kyoto (JP)

(73) Assignee: Maxell, Ltd., Kyoto (JP)

(21) Appl. No.: 18/039,983

(22) PCT Filed: Nov. 26, 2021
(86) PCT No.: PCT/JP2021/043392

§ 371 Date: Jun. 2, 2023

(30) Foreign Application Priority Data
Dec. 4, 2020 (JP) 2020-202251
Jul. 21, 2021 (JP) 2021-120807

(51) Int. Cl. G02B 30/56; G02B 5/26; G02B 5/22; G02B 5/30; G02B 1/11; H04N 13/39

(52) U.S. Cl. CPC G02B 30/56; G02B 5/26; G02B 5/22; G02B 5/3083; G02B 1/11; H04N 13/39

(57) ABSTRACT

An air-floating-video display apparatus includes a Liquid Crystal Display panel, a light source apparatus configured to supply a light in a specific polarization direction to the LCD panel, and a retroreflector that includes a phase difference plate on a retroreflection surface. A polarization separation member is disposed in a space between the LCD panel and the retroreflector. The polarization separation member is configured to once transmit a video light of a specific polarization from the LCD panel to the retroreflector, perform polarization conversion on the video light by the retroreflector and convert the video light into a video light of another polarization to cause the video light to be reflected by the polarization separation member, and display an air-floating-video as a real image at a side opposite to the LCD panel in a transparent member through which the video light of the specific polarization passes.

### TECHNICAL FIELD

The present invention relates to an air floating video display apparatus and a light source apparatus.

### BACKGROUND ART

As one example of an air floating video display apparatus, Patent Document 1 discloses description that “A CPU of an information processing apparatus includes an approaching-direction detector that detects an approaching direction of a user to an image formed in midair, an input-coordinates detector that detects coordinates where an input is detected, an operation receiver that processes reception of an operation, and an operation-screen updater that updates an operation screen in accordance with the received operation. When the user approaches the image from a predetermined direction, the CPU receives the movement of the user as an operation and performs a process according to the operation (extract from ABSTRACT).”
Patent Document 1: Japanese Unexamined Patent Application Publication No. 2019-128722

### DISCLOSURE OF THE INVENTION

### Problems to be Solved by the Invention

Although the above-described air floating video display apparatus of Patent Document 1 can improve operability of an air floating video, improvement in a visual resolution and contrast of the air floating video are not considered, and actually further improvement in video quality has been demanded.

The present invention has been made in the actual condition, and an object of the present invention is to provide an air floating video display apparatus that can display a preferable air floating video with high visibility.

### Solutions to the Problems

To solve the problem, for example, configurations described in the appended claims are employed. Although this application includes a plurality of means to solve the problem, one example is an air floating video display apparatus for forming an air floating video that includes a display panel as a video source, a light source apparatus, and a retroreflector. The light source apparatus is configured to supply a light in a specific polarization direction to the display panel. The retroreflector includes a phase difference plate on a retroreflection surface. A polarization separation member is disposed in a space between the display panel and the retroreflector. The polarization separation member is configured to once transmit a video light of a specific polarization from the display panel to the retroreflector, perform polarization conversion by the retroreflector and convert the video light into a video light of another polarization to cause the video light to be reflected by the polarization separation member, and display the air floating video as a real image at a side opposite to the video source in a transparent member through which the video light of the specific polarization passes.

### Effects of the Invention

According to the present invention, the air floating video display apparatus that can display the preferable air floating video with high visibility can be achieved. Problems, configurations, and effects other than ones described above will be made apparent in the following description of embodiments.

### BRIEF DESCRIPTION OF THE DRAWINGS

FIG. 1 is a drawing illustrating an example of a usage configuration of an air floating video display system according to one embodiment of the present invention.

FIG. 2 is a drawing illustrating an example of a main configuration of the air floating video display system and a retroreflection portion configuration according to one embodiment of the present invention.

FIG. 3 is a drawing illustrating a problem of the air floating video display system.

FIG. 4 is a characteristic diagram representing a relationship between surface roughness of a retroreflector and an amount of blur of a retroreflection image.

FIG. 5 is a drawing illustrating a problem of the air floating video display system.

FIG. 6A is a drawing illustrating another embodiment of a main configuration of the air floating video display apparatus according to one embodiment of the present invention.

FIG. 6B is a drawing illustrating another embodiment of a main configuration of the air floating video display apparatus according to one embodiment of the present invention.

FIG. 6C is a drawing illustrating another embodiment of a main configuration of the air floating video display apparatus according to one embodiment of the present invention.

FIG. 6D is a drawing illustrating another embodiment of a main configuration of the air floating video display apparatus according to one embodiment of the present invention.

FIG. 6E is a drawing illustrating another embodiment of a main configuration of the air floating video display apparatus according to one embodiment of the present invention.

FIG. 7 is a cross-sectional view illustrating an example of a specific configuration of a light source apparatus.

FIG. 8 is a cross-sectional view illustrating an example of a specific configuration of the light source apparatus.

FIG. 9 is a cross-sectional view illustrating an example of a specific configuration of the light source apparatus.

FIG. 10 is a layout drawing illustrating a main part of the air floating video display system according to one embodiment of the present invention.

FIG. 11 is a cross-sectional view illustrating a configuration of a video display apparatus constituting the air floating video display system according to one embodiment of the present invention.

FIG. 12 is a cross-sectional view illustrating an example of a specific configuration of the light source apparatus.

FIG. 13 is a cross-sectional view illustrating an example of a specific configuration of the light source apparatus.

FIG. 14 is a cross-sectional view illustrating an example of a specific configuration of the light source apparatus.

FIG. 15 is an explanatory view for describing diffusion characteristics of the video display apparatus.

FIG. 16 is an explanatory view for describing the diffusion characteristics of the video display apparatus.

FIG. 17 is a cross-sectional view illustrating the configuration of the video display apparatus constituting the air floating video display system according to one embodiment of the present invention.

FIG. 18 is a drawing illustrating an example of the specific configuration of the light source apparatus according to one embodiment of the present invention.

### DESCRIPTION OF PREFERRED EMBODIMENTS

Hereinafter, embodiments of the present invention will be described in detail based on the drawings. The present invention is not limited to the description of embodiments, and various changes and modifications are possible by the person skilled in the art within the scope of the technical idea disclosed in this Description. In all drawings for describing the present invention, the same reference numeral is given to the one having the same function and repeated description thereof will be omitted in some cases. The following description of the embodiments expresses a video floating in a space by a term, an “air floating video.” Instead of the term, the video may be expressed as an “aerial floating video,” an “air floating optical image of a display video,” or an “aerial floating optical image of a display video.” The term “air floating video” used in the description of the embodiments is used as a representative example of the terms.

The following embodiments relate to an air floating video display system that, for example, can transmit a video by video light from a large-area video light emitting source via a transparent member, such as a glass of a show window, that partitions a space and display the video inside or outside a shop (space) as an air floating video. Additionally, the following embodiments relate to a large-scale digital signage system constituted by use of a plurality of the air floating video display systems.

According to the following embodiments, video information with high resolution can be displayed in an air floating state on, for example, a glass surface of a show window or a board material having optical transparency. At this time, by configuring a divergence angle of the video light to be emitted to be small, namely, an acute angle and further uniforming the video light so as to be a specific polarization, only proper reflected light is efficiently reflected by a retroreflector. Therefore, usage efficiency of light is high, ghost images generated in addition to a main air floating video, which have been a problem in the conventional retroreflection method, can be suppressed, and a clear air floating video can be obtained. The air floating video display system that is novel and excellent in availability in which power consumption can be substantially reduced by an apparatus including a light source of this embodiment can be provided. For example, a vehicular air floating video display system that allows visual perception outside a vehicle via a shield glass including a front glass, a rear glass, and a side glass of a vehicle, what is called unidirectional air floating video display can be provided.

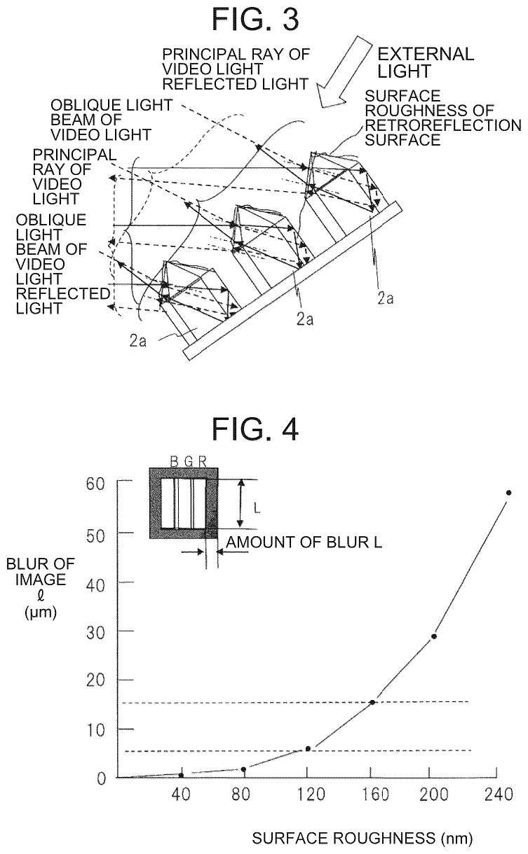

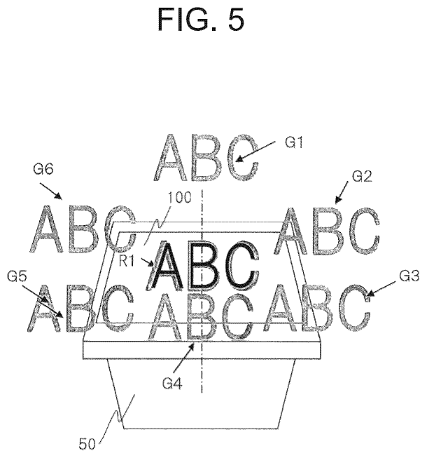

On the other hand, in the conventional air floating video display system, as a color display video source with high resolution, an organic EL panel or a liquid crystal display panel is combined with a retroreflector. Since video light diffuses at a wide angle in the air floating video display apparatus according to the prior art and a retroreflection portion is a hexahedron, in addition to reflected light that is properly reflected, due to video light obliquely entering a retroreflector (retroreflection sheet) 2 as illustrated in FIG. 3, a ghost image is generated, thus degrading the image quality of the air floating video. Since the retroreflector described as the prior art is the hexahedron, in addition to a proper image R1 of an air floating video, a plurality of a first ghost image G1 to a sixth ghost image G6 are generated as illustrated in FIG. 5. Thus, except for a watcher, the ghost image as the same air floating video is monitored, causing a big problem in terms of security.

In an air floating video obtained by reflecting the video light from a video display apparatus having a narrow-angle directivity described later by the retroreflector, blur was visually perceived in each pixel of a liquid crystal display panel as illustrated in FIG. 4 in addition to the above-described ghost images.

<Air Floating Video Display System (1)>

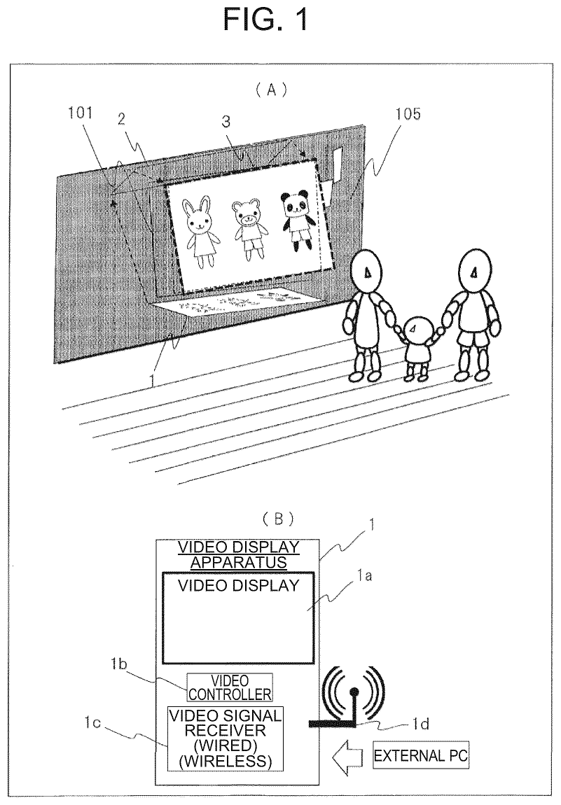

FIG. 1 is a drawing illustrating an example of usage configuration of the air floating video display system according to one embodiment of the present invention. FIG. 1A is a drawing illustrating an overall configuration of the air floating video display system according to this embodiment. For example, in a shop or the like, a space is partitioned by a show window (a window glass 105) as a translucent member, such as a glass. An air floating video display system according to this embodiment can cause a floating video to pass through the transparent member to display the floating video outside the shop (the space) in one direction. Specifically, light having a narrow-angle directivity and of a specific polarization is emitted from a video display apparatus 1 as video light flux, once enters a retroreflector 2, performs retroreflection, and passes through the window glass 105 to form an aerial image (an air floating video 3) as a real image outside the shop. FIG. 1 illustrates an inside of the window glass 105 (an inside of the shop) at the far side and the outside (for example, a sidewalk) at the near side. On the other hand, by providing means of reflecting the specific polarization by the window glass 105 for reflection, the aerial image can be formed at a desired position inside the shop.

FIG. 1B is a block diagram illustrating a configuration of the video display apparatus 1 described above. The video display apparatus 1 includes a video display 1a that displays an original image of the aerial image, a video controller 1b that converts an input video in accordance with a resolution of a panel, a video signal receiver 1c that receives a video signal, and a reception antenna 1d. The video signal receiver 1c handles an input signal in, for example, a wired High-Definition Multimedia Interface (HDMI: registered trademark) input, handles a wireless input signal, such as Wireless Fidelity (Wi-Fi: registered trademark), functions alone as a video reception/display apparatus, and can display video information from, for example, a tablet and a smartphone. Further, connection of a stick PC or the like allows providing ability, such as a calculation process and a video analysis process.

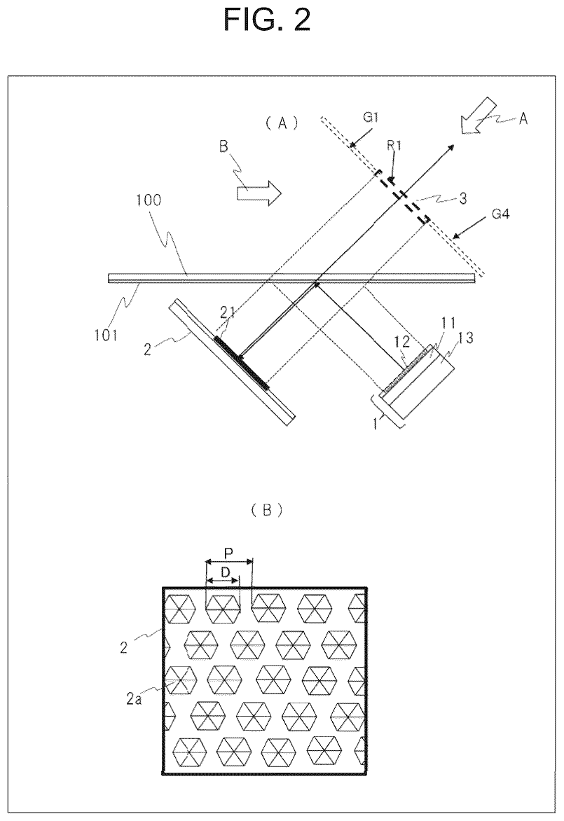

FIG. 2 is a drawing illustrating an example of a main configuration of the air floating video display system and a retroreflection portion configuration according to one embodiment of the present invention. Using FIG. 2, the configuration of the air floating video display system will be more specifically described. As illustrated in FIG. 2A, the video display apparatus 1 that diffuses the video light of the specific polarization at a narrow angle is provided in the oblique direction of a transparent member 100, such as a glass. The video display apparatus 1 includes a liquid crystal display panel 11 and a light source apparatus 13 that generates light of the specific polarization having narrow-angle diffusion characteristics.

The video light of the specific polarization from the video display apparatus 1 is reflected by a polarization separation member 101 (in the drawing, the polarization separation member 101 is formed in a sheet shape and stuck to the transparent member 100), which has a film that selectively reflects the video light of the specific polarization and is disposed on the transparent member 100, and enters the retroreflector 2. A λ/4 plate 21 is disposed on a video light incidence surface of the retroreflector. The video light is caused to pass through the λ/4 plate 21 twice at entrance to and emission from the retroreflector 2, and thus polarization conversion from the specific polarization into another polarization is performed. Here, the polarization separation member 101, which selectively reflects the video light of the specific polarization, has characteristics of transmitting polarized light of the other polarization on which polarization conversion has been performed and therefore the video light of the specific polarization after the polarization conversion passes through the polarization separation member 101. The video light that has passed through the polarization separation member 101 forms the air floating video 3 as a real image outside the transparent member 100.

The light that forming the air floating video 3 is a collection of light beam converged to the optical image of the air floating video 3 from the retroreflector 2, and the light beam goes straight even after passing through the optical image of the air floating video 3. Accordingly, different from diffusion video light formed on a screen by a general projector or the like, the air floating video 3 is a video having high directionality. Accordingly, in the configuration of FIG. 2, when a user visually perceives the air floating video 3 in the arrow A direction, the air floating video 3 is visually perceived as a bright video. However, when another person visually perceives the air floating video 3 in the arrow B direction, the air floating video 3 cannot be visually perceived as a video at all. The characteristics are particularly preferable in a case where the air floating video 3 is employed for a system that displays a video required to have high security and a video having high secrecy desired to be concealed from a person who stands facing the user.

There may be a case where polarizing axes of the video light after reflection become non-uniform depending on the performance of the retroreflector 2. In this case, a part of the video light with the non-uniform polarizing axes is reflected by the above-described polarization separation member 101 and returns to the video display apparatus 1. The light is possibly reflected again by a video display surface of the liquid crystal display panel 11 constituting the video display apparatus 1 to generate ghost images, thereby deteriorating the image quality of the air floating video. Therefore, in this embodiment, an absorptive polarizing plate 12 is disposed on the video display surface of the video display apparatus 1. The video light emitted from the video display apparatus 1 is caused to pass through the absorptive polarizing plate 12 and the reflected light returned from the polarization separation member 101 is absorbed by the absorptive polarizing plate 12, thus ensuring suppressing the re-reflection. This allows reducing the deterioration of the image quality due to the ghost images of the air floating video.

The polarization separation member 101 described above only needs to be formed by, for example, a reflective polarizing plate or a metal multilayer film by which a specific polarization is reflected.

Next, FIG. 2B illustrates the surface shape of the retroreflector 2 manufactured by NIPPON CARBIDE INDUSTRIES CO., INC. used for examination of this time as the representative retroreflector 2. Light beam that has entered inside retroreflection portions 2a formed of hexagonal columns and regularly arrayed is reflected by wall surfaces and bottom surfaces of the hexagonal columns and emits in a direction corresponding to the incident light as retroreflection light to form a proper image R1 illustrated in FIG. 5. On the other hand, as illustrated in FIG. 3, in the video light from the video display apparatus 1, the ghost images (G1 to G6 in FIG. 5) are formed separately from the proper image R1 depending on the video light that has obliquely entered the retroreflector 2.

Therefore, on the basis of the video displayed on the video display apparatus 1 of the present invention, the air floating video 3 as the real image is displayed without forming ghost images. The resolution of the air floating video 3 significantly depends on an outer diameter D and a pitch P of the retroreflection portions 2a of the retroreflector 2 illustrated in FIG. 2B in addition to the resolution of the liquid crystal display panel 11. For example, to use the 7-inch WUXGA (1920×1200 pixels) liquid crystal display panel 11, even when one pixel (one triplet) is about 80 μm, for example, when the diameter D of the retroreflection portions 2a is 240 μm and the pitch is 300 μm, one pixel of the air floating video 3 is equivalent to 300 μm. In view of this, the effective resolution of the air floating video 3 decreases to around ⅓. Thus, to equalize the resolution of the air floating video 3 with the resolution of the video display apparatus 1, the diameter and the pitch of the retroreflection portions 2a preferably approach one pixel of the liquid crystal display panel. Meanwhile, to suppress moire due to the retroreflector 2 and the pixels of the liquid crystal display panel 11, each of pitch ratios is preferably designed outside of integer multiples of one pixel. Regarding the shape, it is preferable to dispose any one side of the retroreflection portion 2a does not overlap with any one side of one pixel of the liquid crystal display panel 11.

The inventors manufactured the video display apparatus 1 in which a liquid crystal display panel with a pixel pitch of 40 μm was combined with a light source at a narrow divergence angle (a divergence angle: 15°) of the invention of this application and obtained a relationship between an amount of blur l of an image of an air floating video allowable to improve visibility and a pixel size L through experiments. FIG. 4 illustrates the experimental results. It has found that the amount of blur l at which visibility gets worse is preferably 40% or less of the pixel size and the blur is hardly distinct at 15% or less. It has found that a surface roughness of a reflecting surface at which the amount of blur l at this time becomes the allowable amount is average roughness of 160 nm or less in a range of a measurement distance of 40 μm and to make the amount of blur l more indistinctive, the surface roughness of the reflecting surface is preferably 120 nm or less. In view of this, it is preferable to reduce the surface roughness of the retroreflector described above and set surface roughness including a reflective film forming the reflecting surface and a protective film thereof to be the above-described value or less.

On the other hand, to inexpensively manufacture the retroreflectors 2, molding using a roll press method is preferably performed. Specifically, the method is to array the retroreflection portions 2a and form them on a film. The method forms a shape inverse to a shape to be formed on a roll surface, applies an ultraviolet ray curable resin on a base material for fixation and causes the base material to pass through between the rolls to form the required shape, and irradiates it with ultraviolet rays to harden, thus obtaining the retroreflectors 2 having the desired shape.

The video display apparatus 1 of the present invention has a system excellent in structure in which a possibility of entering of the video obliquely with respect to the above-described retroreflector 2 is small, occurrence of ghosts is low, and even when ghosts occur, luminance is low by the liquid crystal display panel 11 and the light source apparatus 13 generating the light of the specific polarization having the narrow-angle diffusion characteristics described in detail later.

<Air Floating Video Display System (2)>

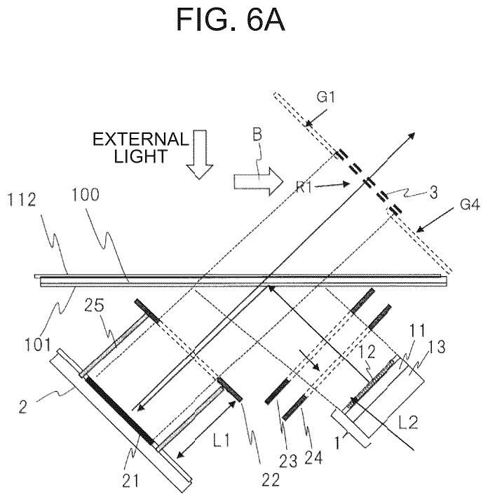

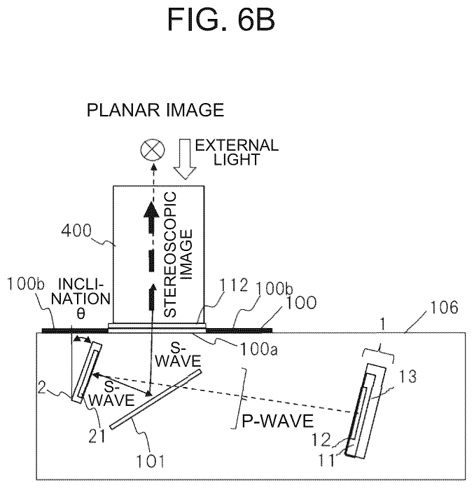

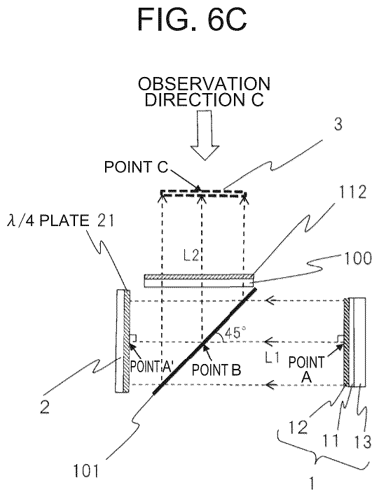

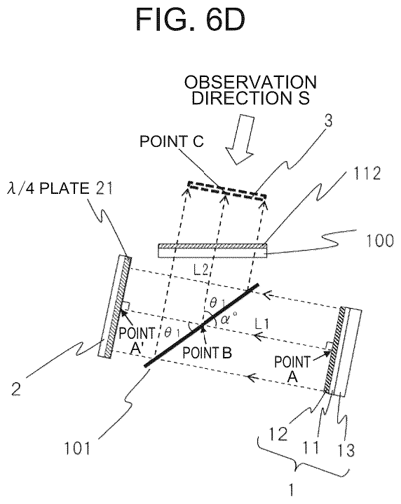

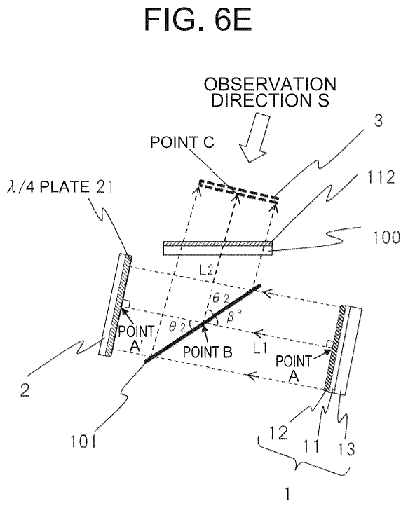

FIG. 6A is a drawing illustrating another example (a second example) of a main configuration of the air floating video display system according to one embodiment of the present invention. The video display apparatus 1 includes: the liquid crystal display panel 11 as a video display element; and the light source apparatus 13 that generates the light of the specific polarization having the narrow-angle diffusion characteristics. The liquid crystal display panel 11 is constituted of a small-sized liquid crystal display panel having a screen size of around 5 inches or a large-sized liquid crystal display panel having a screen size exceeding 80 inches. For example, the polarization separation member 101, such as a reflective polarizing plate, causes the video light from the liquid crystal display panel to be reflected toward the retroreflector 2.

The λ/4 plate 21 is disposed on a light incidence surface of the retroreflector 2, a polarization conversion is performed by causing the video light to pass through twice to convert the specific polarization into another polarization, and thus the video light is caused to be transmitted through the polarization separation member 101, thus displaying the air floating video 3 as the real image outside the transparent member 100. The absorptive polarizing plate is disposed on an external light incidence surface of the transparent member 100. Since retroreflection makes the polarizing axes non-uniform, a part of the video light is reflected by the above-described polarization separation member 101 and returns to the video display apparatus 1. The light reflected by the video display surface of the liquid crystal display panel 11 constituting the video display apparatus 1 again and generates ghost images, thus significantly deteriorating the image quality of the air floating video 3. Therefore, in this embodiment, the absorptive polarizing plate 12 is disposed on the video display surface of the video display apparatus 1, the video light is caused to pass through, and the above-described reflected light is absorbed to reduce the deterioration of the image quality by the ghost images of the air floating video 3.

Further, to reduce the deterioration of the image quality due to sunlight outside a set and illuminating light, an absorptive polarizing plate 112 is preferably disposed on the surface of the transparent member 100. Further, since entrance of external light to the retroreflector 2 generates a strong ghost image, the entrance of external light is hindered by a fourth light shielding member 25. The polarization separation member 101 is formed by the reflective polarizing plate or the metal multilayer film that causes the specific polarization to be reflected.

Between the polarization separation member 101 and the liquid crystal display panel 11, a second light shielding member 23 and a third light shielding member 24 that shield oblique video light other than the proper video light forming the air floating video are disposed together. Additionally, between the retroreflector 2 and the polarization separation member 101, a first light shielding member 22 that shields the oblique video light other than the proper video light is disposed, and further, as described above, the fourth light shielding member 25 is disposed together to avoid external light to directly enter the retroreflector 2 to shield the oblique light that generates ghost images. As a result, ghost images can be reduced.

The inventors have confirmed through experiments that disposing the third light shielding member 24 and the second light shielding member 23 in the space between the liquid crystal display panel 11 and the polarization separation member 101 together enhances the effect of light shielding. In this experiment, by configuring areas of inner diameters of the second light shielding member 23 and the third light shielding member 24 to be 110% of a region through which the proper video light flux forming the air floating video passes, they can be manufactured and assembled with component accuracy in a range of machine tolerance. Further, in order to reduce ghost images, by configuring the area to be 104% or less of the region through which the proper video light flux passes of the light shielding member described above, ghost images were able to be suppressed to a level not practically causing a problem. Meanwhile, when a distance L1 between the first light shielding member 22 and the retroreflector 2 is 50% or less of a distance between the retroreflector 2 and the polarization separation member 101, the first light shielding member 22 disposed between the retroreflector 2 and the polarization separation member 101 was further able to reduce ghost images and when the distance L1 is 30% or less, ghost images were able to be reduced to a level not practically causing a problem in visual check. Further, disposing the fourth light shielding member 25, the first light shielding member 22, the second light shielding member 23, and the third light shielding member 24 together so as to surround the retroreflector 2 allowed further reducing generation of ghosts.

It is more preferable that the cross-sectional shape of the light shielding member in FIG. 6A is configured to have an approximately the same size as an effective area of the light shielding member with respect to the region through which the proper video light flux forming the air floating video passes (equivalent to a region through which the video light flux passes in the absorptive polarizing plate 112 in this embodiment), a beam is disposed toward the inner surface, and abnormal light forming a ghost image is caused to be reflected by a surface of the beam multiple times to absorb the abnormal light. The region through which the proper video light flux passes is configured to be smaller than a light shielding member outer frame so as to have an area equal to the inscribed surface of the beam.

Meanwhile, the shape of the retroreflector 2 may be a concave surface or a convex surface from a planar shape facing the video display apparatus 1 at a curvature radius of 200 mm or more, and thus, even when a ghost image is generated by oblique video light reflected by the retroreflector 2, by separating the ghost image generated after the reflection from eyesight of the watcher, the watcher cannot perform monitoring. A new problem that, in the light reflected by the periphery of the retroreflector 2 having the curvature radius of 100 mm or less, an amount of light that is properly reflected decreases and obtained peripheral illumination of the air floating video 3 decreases occurs. In view of this, to reduce ghost images to the level of not practically causing a problem, the above-described technical means is preferably selected and applied or used in combination.

<Air Floating Video Display System (3)>

FIG. 6B is a drawing illustrating another example (a third example) of a main configuration of the air floating video display apparatus according to one embodiment of the present invention. The video display apparatus 1 includes the liquid crystal display panel 11 as the video display element and the light source apparatus 13 that generates the light of the specific polarization having the narrow-angle diffusion characteristics. The liquid crystal display panel 11 is constituted of the small-sized liquid crystal display panel 11 having a screen size of around 5 inches or the large-sized liquid crystal display panel 11 having a screen size exceeding 80 inches. For example, the polarization separation member 101, such as a reflective polarizing plate, once transmits the video light from the liquid crystal display panel 11 toward the retroreflector 2.

The λ/4 plate 21 is disposed on a light incidence surface of the retroreflector 2, a polarization conversion is performed by causing the video light to pass through twice to convert the specific polarization into another polarization, and thus the video light is caused to be reflected by the polarization separation member 101, thus displaying the air floating video 3 as the real image outside the transparent member 100. The absorptive polarizing plate 112 is disposed on an external light incidence surface of the transparent member 100. The transparent member 100 has a transparent body only at a part through which the video light passes and the other part is constituted by a light shielding member 100b that blocks light to avoid external light to enter inside the set. There may be a case where the polarizing axes of the video light after reflection become non-uniform depending on the performance of the retroreflector 2. In this case, a part of the video light with the non-uniform polarizing axes is reflected by the polarization separation member 101 and returns to the video display apparatus 1. The light is re-reflected by a video display surface of the liquid crystal display panel 11 constituting the video display apparatus 1 again to generate ghost images, significantly deteriorating the image quality of the air floating video 3. Therefore, in this embodiment, the absorptive polarizing plate 12 is further disposed on the video display surface of the video display apparatus 1. Alternatively, by disposing an anti-reflection film (not illustrated) on a video emission side surface of the absorptive polarizing plate 12 disposed on the surface of the video display apparatus 1, the light of the ghost image is caused to pass through, and by absorbing the light by the absorptive polarizing plate 12, the deterioration of the image quality by the ghost image of the air floating video 3 is reduced.

Further, to reduce the deterioration of the image quality by sunlight and illuminating light outside a housing 106 that houses the video display apparatus 1 and the other optical components, the absorptive polarizing plate 112 is preferably disposed on an external surface of the transparent member 100. Further, when external light enters the retroreflector 2, a strong ghost image is generated. Accordingly, the retroreflector 2 is inclined (an inclination θ), and the retroreflector 2 is disposed at a position apart from a window portion 100a formed of a transparent body through which the retroreflection video light passes to hinder the entrance of the external light. Similarly, the video display apparatus 1 is also disposed at a position apart from the window portion 100a, and disposing the video display apparatus 1 at a position where the video light emitted from the video display apparatus 1 cannot be visually perceived from the window portion 100a reduces ghost images (the window portion 100a is one configuration of an aperture).

The polarization separation member 101 is formed by the reflective polarizing plate or the metal multilayer film that causes the specific polarization to be reflected.

The air floating video 3 emitted from the window portion 100a is reflected by a reflective mirror 400. At this time, setting an angle of the reflective mirror 400 to a desired angle with respect to the plane of the window portion 100a allows changing the position and the angle of the obtained air floating video 3. When the reflective mirror 400 having characteristics of high reflectivity of the specific polarization is used, the reflective mirror 400 can be used as a mirror having high transmittance. When the reflective mirror 400 is an optical system that obtains air floating video light of a S polarization, the use of a transparent mirror allows obtaining high reflectivity without forming a reflective film. Consequently, the use of the transparent mirror allows obtaining the satisfactory air floating video with high visibility (described as a stereoscopic image in FIG. 6B), and this does not become an obstacle when the watcher monitors an outside scenery. On the other hand, as illustrated in FIG. 6B, an optical system excluding the reflective mirror 400 allows obtaining the planar image illustrated in the drawing with the video light that has passed through the window portion 100a.

<Air Floating Video Display System (4)>

FIG. 6C is a drawing illustrating another example (a fourth example) of a main configuration of the air floating video display apparatus according to one embodiment of the present invention. In FIG. 6C, similarly to FIG. 6B, the video display apparatus 1 includes the liquid crystal display panel 11 as the video display element and the light source apparatus 13 that generates the light of the specific polarization having the narrow-angle diffusion characteristics. The liquid crystal display panel 11 is constituted of the small-sized liquid crystal display panel 11 having a screen size of around 5 inches or the large-sized liquid crystal display panel 11 having a screen size exceeding 80 inches. For example, the polarization separation member 101, such as a reflective polarizing plate, once transmits the video light from the liquid crystal display panel 11 toward the retroreflector 2, and the transmitted video light is reflected by the retroreflector 2. Here, the polarization separation member 101 is also referred to as a beam splitter and transmits the video light in association with specific polarized light (P-polarized light or S-polarized light), but has a feature of by which video light in association with polarized light different from the specific polarized light (the S polarized light or the P-polarized light) is reflected.

The λ/4 plate 21 is disposed on a light incidence surface of the retroreflector 2, a polarization conversion is performed by causing the video light to pass through twice to convert the specific polarization into another polarization, and thus the video light is caused to be reflected by the polarization separation member 101, thus displaying the air floating video 3 as the real image outside the transparent member 100. Similarly to FIG. 6B, the absorptive polarizing plate 112 is disposed on an external light incidence surface of the transparent member 100. Although not illustrated, similarly to FIG. 6B, the light shielding member 100b may surround the peripheral area of the transparent member 100 such that external light does not enter the retroreflector 2 or the video display apparatus 1.

Using FIG. 6C, arrangement of the main configuration of the air floating video display apparatus will be described. In FIG. 6C, when observed from an observation direction C indicated by the arrow direction, the air floating video 3 in a two-dimensional planar shape can be observed. The position where the air floating video 3 is formed is determined as follows. In FIG. 6C, the video display apparatus 1 and the retroreflector 2 are disposed to be parallel to one another, and specifically, the video display surface of the liquid crystal display panel 11 constituting the video display apparatus 1 is disposed opposed to the reflecting surface of the retroreflector 2. Accordingly, the preferred air floating video 3 can be observed. On the other hand, the video display surface of the liquid crystal display panel 11 constituting the video display apparatus 1 and the reflecting surface of the retroreflector 2 may be disposed to be approximately parallel to one another. When the angle mutually formed is around 10 degrees, a generated ghost image does not practically become a problem, that is, even when a ghost image is generated, it hardly affects the visibility of the air floating video 3.

A point B is defined such that, a line segment A-A′ connecting any point A on the liquid crystal display panel 11 constituting the video display apparatus 1 (here, one point at the center on the liquid crystal display panel 11) and a corresponding point A′ on the retroreflector 2 (similarly, one point at the center on the retroreflector 2) intersects with the polarization separation member (the beam splitter) 101, and a length of a line segment AB is defined as L1. The line segment A-A′ is an optical axis of the video light emitted from the video display surface of the liquid crystal display panel 11, and the emission direction of the light source is approximately perpendicular to the video display surface of the liquid crystal display panel 11, or the line segment A-A′ is approximately perpendicular or perpendicular to the video display surface of the liquid crystal display panel 11. Next, a point having a length L2 in the vertical direction (the direction of disposing the transparent member 100 in FIG. 6C) from the point B on the polarization separation member 101 is defined as a point C, and the length L1 of the line segment AB is approximately the same length as the length L2 of a line segment BC. The air floating video 3 is formed on the two-dimensional plane with the point C as the center.

Here, while one point A at the center on the liquid crystal display panel 11 has been described, regarding any point on the liquid crystal display panel 11, the relationship of L1=L2 is satisfied. Accordingly, in FIG. 6C, when the liquid crystal display panel 11 is disposed far from the point B of the polarization separation member 101, L1 lengthens and L2 also lengthens from the relationship L1=L2, and thus the position where the air floating video 3 is formed becomes further upward. That is, the distance from the window portion 100a constituted by the transparent member 100 to the air floating video 3 lengthens. Accordingly, the display position of the air floating video 3 changes according to the distance between the liquid crystal display panel 11 and the polarization separation member 101. That is, the display position of the air floating video 3 is a position determined according to the distance between the liquid crystal display panel 11 and the polarization separation member 101.

However, when the video light having the same intensity is emitted from the liquid crystal display panel 11, disposing the liquid crystal display panel 11 far from the polarization separation member 101 lengthens the distance between the liquid crystal display panel 11 and the retroreflector 2. Thus, the intensity (the luminance) of the video light reaching the retroreflector 2 from the liquid crystal display panel 11 lowers and, as a result, the brightness of the air floating video 3 also decreases. Accordingly, since the distance from the displayed air floating video 3 to the transparent member 100 and the brightness of the air floating video 3 are in the trade-off relationship, adjusting the disposed positions of the liquid crystal display panel 11 and the polarization separation member 101 allows displaying the preferable air floating video 3 with high visibility.

As apparent from FIG. 6C, when the angle formed by the polarization separation member 101 and the line segment A-A′ (the optical axis of the video light emitted from the liquid crystal display panel 11) is 45 degrees, the video generated by the video display apparatus 1 and the air floating video 3 have the same size. On the other hand, although not illustrated, when the angle is greater than 45 degrees, the width of the air floating video 3 becomes smaller than the video generated by the video display apparatus 1, and conversely, when the angle is smaller than 45 degrees, the width of the air floating video 3 becomes larger than the video generated by the video display apparatus 1.

<Air Floating Video Display System (5)>

FIG. 6D and FIG. 6E are drawings illustrating another example (a fifth example) of a main configuration of the air floating video display apparatus according to one embodiment of the present invention. The air floating video display apparatus illustrated in FIG. 6D is constituted of the components same as those in FIG. 6C, that is, the video display apparatus 1, the retroreflector 2, the λ/4 plate 21, the polarization separation member 101, the transparent member 100, and the like. The video display surface of the liquid crystal display panel 11 constituting the video display apparatus 1 is disposed opposed to a retroreflection surface of the retroreflector 2.

However, FIG. 6D and FIG. 6C differ in that although the video display surface of the liquid crystal display panel 11 constituting the video display apparatus 1 is disposed opposed to the reflecting surface of the retroreflector 2, the retroreflector 2 is positioned upward of the video display apparatus 1. That is, the video display apparatus 1 is disposed at a position apart from the transparent member 100. Accordingly, disposing the video display apparatus 1 at the position where the video light emitted from the video display apparatus 1 cannot be visually perceived from the transparent member 100 reduces ghost images. The retroreflector 2 is inclined and disposed at a position apart from the transparent member 100 through which the retroreflection video light passes to hinder the entrance of external light. That is, they differ in that the direction of the video light emitted from the liquid crystal display panel 11 constituting the video display apparatus 1, in other words, the line segment A-A′ connecting the point A and the point A′ is horizontal in FIG. 6C, but is inclined to be obliquely upward to the left and the angle formed by the line segment A-A′ and the polarization separation member 101 is greater than 45 degrees in FIG. 6D. As the above-described result, the inclined air floating video 3 can be observed.

Further, while the air floating video 3 is formed horizontally in FIG. 6C, the air floating video 3 is formed to have the inclination angle according to the inclination of the line segment A-A′ and the inclination angle of the polarization separation member 101 in FIG. 6D. That is, changing the inclination of the line segment A-A′ and the inclination angle of the polarization separation member 101 allows adjusting the angle of the plane where the air floating video 3 is formed and an observation direction S of the user can be an appropriate angle.

The air floating video display apparatus illustrated in FIG. 6E is constituted by the components which are the same as those of FIG. 6D, and the arrangements of the components are the same. However, the inclination of the polarization separation member 101 is larger than that of FIG. 6D (has the inclination angle closer to horizontal). Therefore, an angle R formed by the optical axis of the video light, namely, the line segment A-A′ and the polarization separation member 101 is smaller than an angle α in FIG. 6D. That is, the relationship of the angle α>the angle β is met.

From the above-described relationship (the angle α>the angle β), as illustrated in FIG. 6E, the observation direction S of the air floating video 3 is a direction away from the vertical compared with FIG. 6D. Furthermore, the observed air floating video 3 is inclined more than FIG. 6D.

As described above, adjusting the direction of the video light, that is, the angle (a or D) formed by the line segment A-A′ and the polarization separation member 101 allows changing the angle formed by the air floating video 3 and the transparent member 100. This allows obtaining the preferred observation direction for the user.

<Reflection Polarizing Plate>

The reflection polarizing plate having a grid structure of the present invention decreases the characteristics about light in the perpendicular direction with respect to the polarizing axis. In view of this, a specification along the polarizing axis is preferred, and the light source of this embodiment configured to emit the video light emitted from the liquid crystal display panel 11 at a narrow angle is an ideal light source. Similarly, the characteristics in the horizontal direction also decrease about oblique light. Considering the above-described characteristics, hereinafter, an exemplary configuration of this embodiment that uses a light source configured to emit the video light emitted from the liquid crystal display panel 11 at a further narrow angle as a backlight of the liquid crystal display panel 11 will be described. This allows providing the air floating video 3 with high contrast.

<Video Display Apparatus>

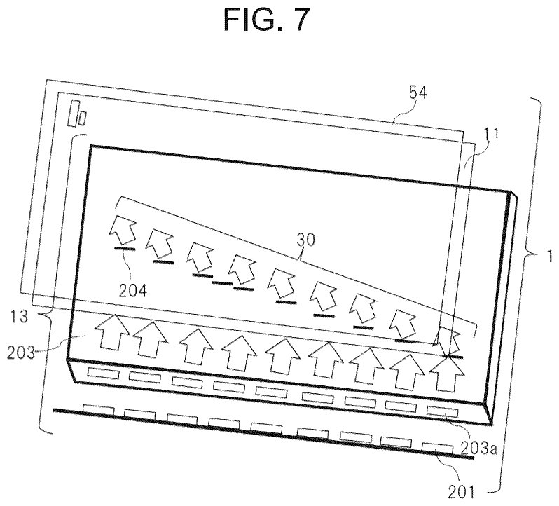

Next, the video display apparatus 1 of this embodiment will be described with reference to the drawings. The video display apparatus 1 of this embodiment includes the light source apparatus 13 constituting the light source together with the video display element (the liquid crystal display panel 11). FIG. 7 illustrates the light source apparatus 13 together with the liquid crystal display panel as a developed perspective view.

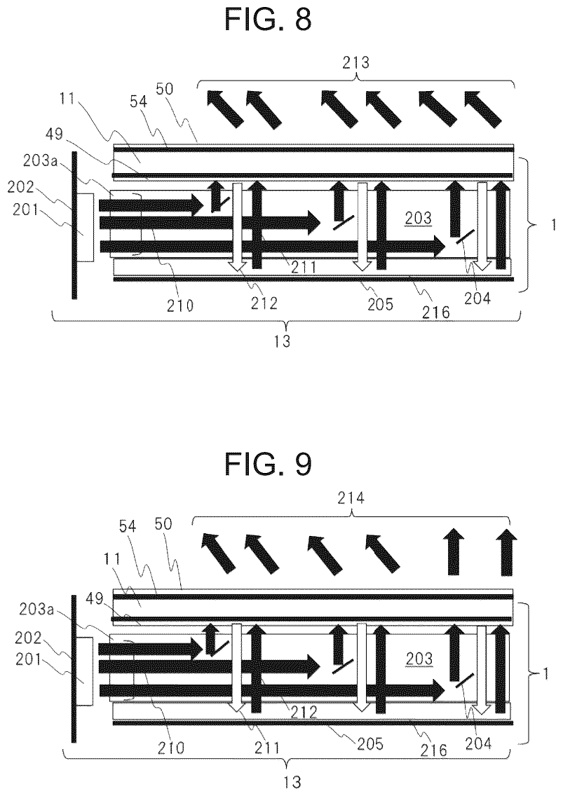

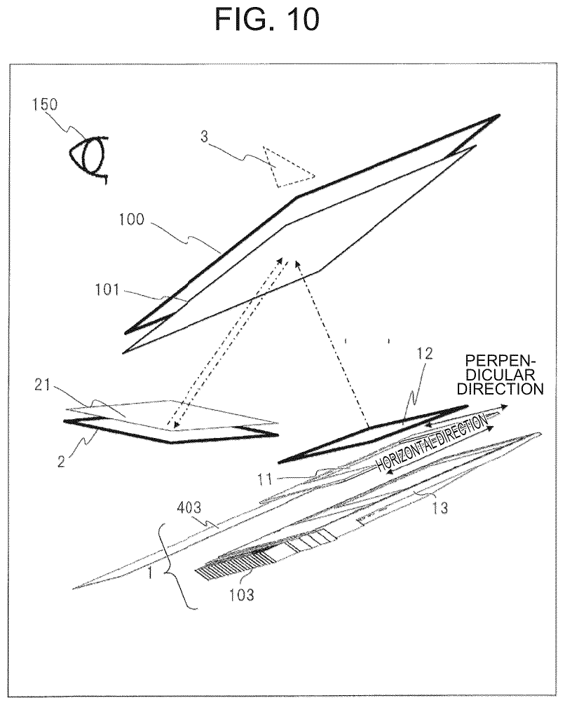

As illustrated in FIG. 7 by arrows 30, the liquid crystal display panel (the video display element) has narrow-angle diffusion characteristics by the light from the light source apparatus 13 as a backlight apparatus. That is, the directionality (the straightness) is strong, illumination luminous flux having the characteristics similar to laser light in which polarization surfaces are matched in one direction is obtained, the video light modulated according to the input video signal is reflected by the retroreflector 2, and the video light is caused to pass through the window glass 105 to form the air floating video as the real image (see FIG. 1). Additionally, in FIG. 7, the liquid crystal display panel 11 constituting the video display apparatus 1 and further a light direction conversion panel 54 that controls directional characteristics of light flux emitted from the light source apparatus 13 and as necessary a narrow-angle diffusion plate (not illustrated) are provided. That is, polarizing plates are disposed on both surfaces of the liquid crystal display panel 11, the intensity of the video light of the specific polarization is modulated by the video signal, and the video light is emitted (see the arrows 30 in FIG. 7). Thus, the desired video as the light of the specific polarization with high directionality (straightness) is projected to the retroreflector 2 via the light direction conversion panel 54 and is after reflected by the retroreflector 2, the light is caused to pass through toward eyes of the watcher outside the shop (the space) to form the air floating video 3. A protective cover 50 (see FIG. 8 and FIG. 9) may be disposed on the surface of the light direction conversion panel 54 described above.

In this embodiment, to improve usage efficiency of the light flux (indicated by the arrows 30) emitted from the light source apparatus 13 and substantially reduce the power consumption, the video display apparatus 1 including the light source apparatus 13 and the liquid crystal display panel 11 can project the light from the light source apparatus 13 (see the arrows 30 in FIG. 8) to the retroreflector 2, and after the light is reflected by the retroreflector 2, control the directionality such that the air floating video 3 is formed at the desired position by a transparent sheet (not illustrated) disposed on the surface of the window glass 105. Specifically, the transparent sheet controls an image forming position of a floating video while giving high directionality by an optical component, such as a Fresnel lens and a linear Fresnel lens. Accordingly, the video light from the video display apparatus 1 is efficiently reached to the observer outside the window glass 105 (such as a sidewalk) with high directionality (straightness) like laser light. As a result, the high-grade floating video can be displayed with high resolution and the power consumption by the video display apparatus 1 including Light Emitting Diode (LED) elements 201 of the light source apparatus 13 can be significantly reduced.

### Example (1) of Video Display Apparatus

FIG. 7 is a drawing illustrating another example of the video display apparatus 1. FIG. 8 illustrates a state in which the liquid crystal display panel 11 and the light direction conversion panel 54 are disposed on the light source apparatus 13 of FIG. 7. The light source apparatus 13 is, for example, made of plastic and internally houses the LED elements 201 and a light guiding body 203. The light guiding body 203 has an end surface having a shape such that the cross-sectional area gradually increases toward an opposite surface facing a light receiver in order to convert diverging light from the respective LED elements 201 into approximately parallel light flux as illustrated in FIG. 8 and the like, and has a lens shape to have an action of gradually decreasing the divergence angle by performing the total reflection by multiple times when the light propagates the inside. The liquid crystal display panel 11 constituting the video display apparatus 1 is mounted on the upper surface. Additionally, on one side surface of a case of the light source apparatus 13 (the end surface on the left side in this example), the LED elements 201 as semiconductor light sources and an LED substrate 202 (see FIG. 8) on which a control circuit thereof is mounted, and on the outer surface of the LED substrate 202, a heat sink, which is a member for cooling heat generated in the LED elements 201 and the control circuit, may be mounted.

On a frame (not illustrated) of the liquid crystal display panel 11 mounted on the upper surface of the case of the light source apparatus 13, the liquid crystal display panel 11 mounted on the frame and Flexible Printed Circuits (FPCs) (not illustrated) electrically connected to the liquid crystal display panel 11 and the like are further mounted. That is, the liquid crystal display panel 11 as a video display element modulates intensity of transmitted light on the basis of a control signal from a control circuit (not illustrated) constituting an electronic apparatus and generates a display video together with the LED elements 201 as solid light sources. At this time, since the generated video light has a narrow diffusion angle and contains only a specific polarization component, the new video display apparatus 1 that does not conventionally exist and is close to a surface emission laser video source driven by the video signal is obtained. It is currently impossible technically and safely for the laser apparatus to obtain laser light flux having a size equal to an image obtained by the above-described video display apparatus 1. Therefore, in this embodiment, for example, the light close to the surface emission laser video light described above is obtained from the light flux from the general light source including the LED elements 201.

Subsequently, the configuration of the optical system housed in the case of the light source apparatus 13 will be described in detail with reference to FIG. 9 together with FIG. 8. Since FIG. 8 and FIG. 9 are cross-sectional views, only one of the plurality of LED elements 201 constituting the light source is illustrated, and they are converted into approximately collimated light by a shape of reception light end surfaces 203a of the light guiding body 203. Therefore, the light receiver on the light guiding body end surface and the LED elements 201 are mounted keeping a predetermined positional relationship. Each of the light guiding bodies 203 is, for example, made of translucent resin, such as acrylic. The LED light-receiving surface of the light guiding body end portion has, for example, an outer peripheral surface having a conical convex shape obtained by rotating a parabolic cross-sectional surface, has a top having a concave portion (namely, a convex lens surface) forming a convex portion at the center, and has a convex lens surface protruded outside (or may be a concave lens portion recessed inside) (not illustrated) at the center of the planar portion. The light receiver outer shape of the light guiding body 203 is a paraboloidal surface shape forming the outer peripheral surface of the cone shape and is set within a range of angles at which the lights emitted from the LED elements 201 in a peripheral direction can be totally reflected by the inside or a reflecting surface is formed.

On the other hand, the respective LED elements 201 are disposed at predetermined positions on the surface of the LED substrate 202 as a circuit board thereof. The LED substrate 202 is fixed such that each of the LED elements 201 on the surface is disposed at a position of the center of the concave portion described above with respect to a LED collimator (the reception light end surface 203a).

With the configuration, the shape of the reception light end surface 203a of the light guiding body 203 allows taking out the light radiated from the LED elements 201 as approximately parallel light and the usage efficiency of the generated light can be improved.

As described above, the light source apparatus 13 is constituted by mounting a light source unit in which a plurality of the LED elements 201 as the light sources are arranged on the reception light end surfaces 203a as the light receivers disposed on the end surface of the light guiding body 203. The light source apparatus 13 converts the divergent light flux from the LED elements 201 into the approximately parallel light by the lens shape of the reception light end surfaces 203a on the light guiding body end surface, guides the light inside the light guiding body 203 as indicated by the arrows (the direction parallel to the drawing), and emits the light toward the liquid crystal display panel 11 (the direction perpendicular to the near side from the drawing) disposed approximately parallel to the light guiding body 203 by light flux direction converting means 204. Optimizing a distribution (density) of the light flux direction converting means 204 by the shape of the inside or the surface of the light guiding body 203 allows controlling the uniformity of light flux entering the liquid crystal display panel 11. By providing a shape of the surface of the light guiding body 203 and/or a part where, for example, a refractive index is different inside the light guiding body 203, the above-described light flux direction converting means 204 emits the light flux propagating inside the light guiding body 203 toward the liquid crystal display panel 11 (the direction perpendicular to the near side of the drawing) disposed approximately parallel to the light guiding body 203. At this time, when a relative luminance proportion comparing luminance at the center of the screen with luminance at the peripheral portion of the screen in a state where the liquid crystal display panel 11 is opposed to the center of the screen and viewpoint is placed at a position which is the same as a screen diagonal dimension is 20% or more, this does not practically cause a problem, and when it exceeds 30%, the characteristics are further excellent.

FIG. 8 is a cross-sectional surface layout drawing for describing the configuration of the light source of this embodiment that performs polarization conversion in the light source apparatus 13 including the light guiding body 203 and the LED elements 201 described above and the action thereof. In FIG. 8, the light source apparatus 13 includes, for example, the light guiding body 203 that includes the light flux direction converting means 204 made of plastic or the like on the surface or the inside, the LED elements 201 as the light sources, a reflection sheet 205, a phase difference plate 216, and a lenticular lens, and the liquid crystal display panel 11 including polarizing plates on the light source light incidence surface and the video light emission surface is mounted on the upper surface.

A film or sheet-shaped reflective polarizing plate 49 is disposed on the light source light incidence surface (the lower surface in the drawing) of the liquid crystal display panel 11 opposed to the light source apparatus 13, a polarization of one side (such as a P-wave) 212 is selectively reflected by the reflective polarizing plate 49 in natural light flux 210 emitted from the LED elements 201, the polarization is reflected by the reflection sheet 205 disposed on the surface one side of the light guiding body 203 (the lower side of the drawing) and is caused to head for the liquid crystal display panel 11 again. Therefore, the phase difference plate 216 (a λ/4 plate) is disposed between the reflection sheet 205 and the light guiding body 203 or between the light guiding body 203 and the reflective polarizing plate 49, the polarization is caused to be reflected by the reflection sheet 205 and pass through twice, thus converting the reflected light flux from the P-polarized light into the S-polarized light and improving the usage efficiency of the light source light as the video light. The video light flux (arrows 213 in FIG. 8) with the optical intensity modulated by the video signal in the liquid crystal display panel 11 enters the retroreflector 2, as illustrated in FIG. 1 and passes through the window glass 105 after reflection to ensure obtaining the air floating video 3 as the real image inside or outside the shop (the space).

Similar to FIG. 8, FIG. 9 is a cross-sectional surface layout drawing for describing the configuration of the light source of this embodiment that performs polarization conversion in the light source apparatus 13 including the light guiding body 203 and the LED elements 201, and the action thereof. Similarly, the light source apparatus 13 includes, for example, the light guiding body 203 that includes the light flux direction converting means 204 made of plastic or the like on the surface or the inside, the LED elements 201 as the light sources, the reflection sheet 205, the phase difference plate 216, and the lenticular lens, and the liquid crystal display panel 11 including the polarizing plates as video display elements on the light source light incidence surface and the video light emission surface is mounted on the upper surface.

The film or sheet-shaped reflective polarizing plate 49 is disposed on the light source light incidence surface (the lower surface in the drawing) of the liquid crystal display panel 11 opposed to the light source apparatus 13, a polarization of one side (such as a S-wave) 211 is selectively reflected by the reflective polarizing plate 49 in the natural light flux 210 emitted from the LED elements 201, the polarization is reflected by the reflection sheet 205 disposed on the surface of one side of the light guiding body 203 (the lower side of the drawing) and is caused to head for the liquid crystal display panel 11 again. The phase difference plate 216 (the λ/4 plate) is disposed between the reflection sheet 205 and the light guiding body 203 or between the light guiding body 203 and the reflective polarizing plate 49, the polarization is caused to be reflected by the reflection sheet 205 and pass through twice, thus converting the reflected light flux from the S-polarized light into the P-polarized light and improving the usage efficiency of the light source light as the video light. The video light flux (arrows 214 in FIG. 9) with the optical intensity modulated by the video signal in the liquid crystal display panel 11 enters the retroreflector 2, as illustrated in FIG. 1 and passes through the window glass 105 after reflection to ensure obtaining the air floating video 3 as the real image inside or outside the shop (the space).

In the light source apparatus 13 illustrated in FIG. 8 and FIG. 9, with the action of the reflective polarizing plate 49 disposed on the light incidence surface of the opposed liquid crystal display panel 11, the polarization component of one side is reflected by the reflective polarizing plate 49. Thus, a contrast ratio obtained in theory is obtained by multiplying an inverse of cross transmittance of the reflective polarizing plate 49 by an inverse of cross transmittance obtained by the two polarizing plates attached to the liquid crystal display panel 11. Thus, high contrast performance is obtained. In practice, it has been confirmed through experiment that contrast performance of a display image is improved 10 times or more. As a result, a high-grade video equivalent to a self-luminous organic EL was obtained.

### Example (2) of Video Display Apparatus

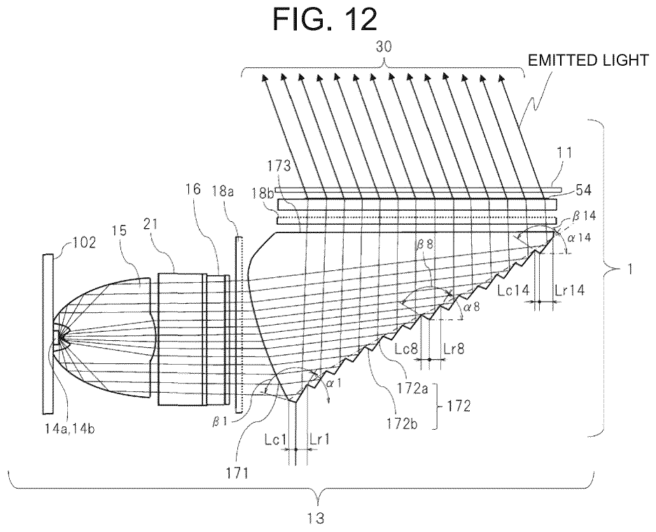

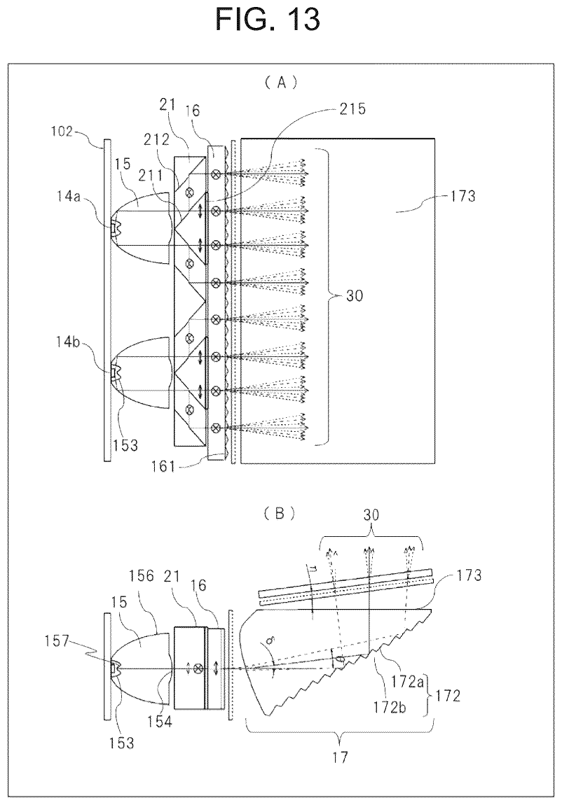

FIG. 10 illustrates another example of the specific configuration of the video display apparatus 1. The light source apparatus 13 in FIG. 10 is similar to the light source apparatus in FIG. 12 or the like. The light source apparatus 13 is constituted by housing a LED, a collimator, a synthetic diffusion block, a light guiding body, and the like in a case made of, for example, plastic, and the liquid crystal display panel 11 is mounted on the upper surface thereof. On one side surface of the case of the light source apparatus 13, Light Emitting Diode (LED) elements 14a, 14b, which are semiconductor light sources illustrated in FIG. 12 and the like, and a LED substrate 102 on which a control circuit thereof is mounted are attached. On the outer surface of the LED substrate 102, a heat sink 103 (see FIG. 10), which is a member for cooling heat generated in the LED elements 14a, 14b and the control circuit is mounted (also see FIG. 12, FIG. 13, and the like).

On a liquid crystal display panel frame mounted on the upper surface of the case, the liquid crystal display panel 11 mounted on the frame and Flexible Printed Circuits (FPCs) 403 (see FIG. 10) electrically connected to the liquid crystal display panel 11 and the like are further mounted. That is, the liquid crystal display panel 11 as a video display element modulates intensity of transmitted light on the basis of a control signal from a control circuit (not illustrated here) constituting an electronic apparatus and generates a display video together with the LED elements 14a, 14b as solid light sources.

### Example (3) of Video Display Apparatus

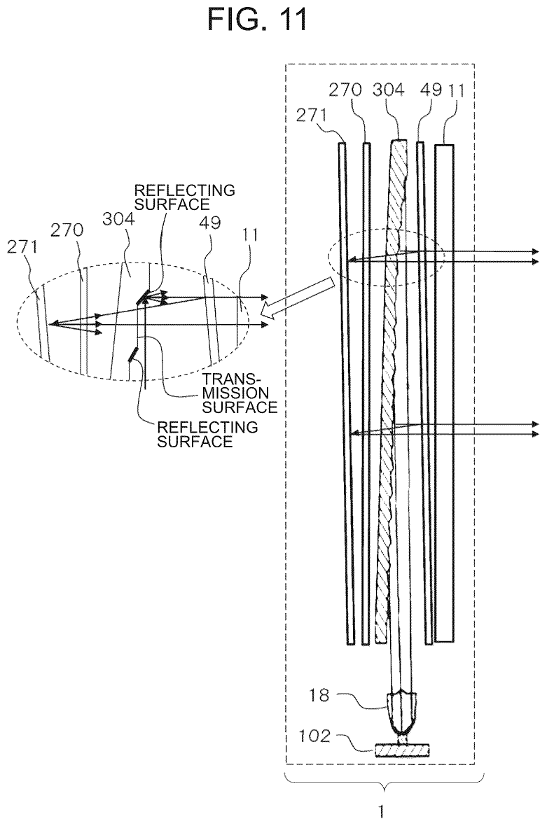

Subsequently, using FIG. 11, another example of the specific configuration of the video display apparatus 1 (the example 3 of the display apparatus) will be described. The light source apparatus of the video display apparatus 1 converts divergent light flux of the light from the LEDs (P-polarized light and S-polarized light are mixed) into approximately parallel light flux by a collimator (a collimator lens or a LED collimator lens) 18 and the approximately parallel light flux is reflected by a reflecting surface of a reflection type light guiding body 304 toward the liquid crystal display panel 11. The reflected light enters the reflective polarizing plate 49 disposed between the liquid crystal display panel 11 and the reflection type light guiding body 304. The reflective polarizing plate 49 transmits the specific polarization (such as the P-polarized light) and the specific polarization enters the liquid crystal display panel 11. The other polarization (such as the S-polarized light) is reflected by the reflective polarizing plate and heads for the reflection type light guiding body 304 again. The reflective polarizing plate 49 is installed to be inclined so as not to be perpendicular to a principal ray of light from the reflecting surface of the reflection type light guiding body 304, and the principal ray of the light reflected by the reflective polarizing plate 49 enters a transmission surface of the reflection type light guiding body 304. The light that has entered the transmission surface of the reflection type light guiding body 304 passes through the back surface of the reflection type light guiding body 304, passes through a λ/4 plate 270 as a phase difference plate, and is reflected by a reflective plate 271. The light reflected by the reflective plate 271 passes through the λ/4 plate 270 again and passes through the transmission surface of the reflection type light guiding body 304. The light that has passed through the transmission surface of the reflection type light guiding body 304 enters the reflective polarizing plate 49 again. At this time, since the light that enters the reflective polarizing plate 49 again has passed through the λ/4 plate 270 twice, the polarized light is converted into the polarization that passes through the reflective polarizing plate 49 (such as the P-polarized light). Accordingly, the light whose polarized light has been converted passes through the reflective polarizing plate 49 and enters the liquid crystal display panel 11. Regarding polarization design according to the polarization conversion, the polarization may be configured reversely to the above-described description (the S-polarized light and the P-polarized light are reversed).

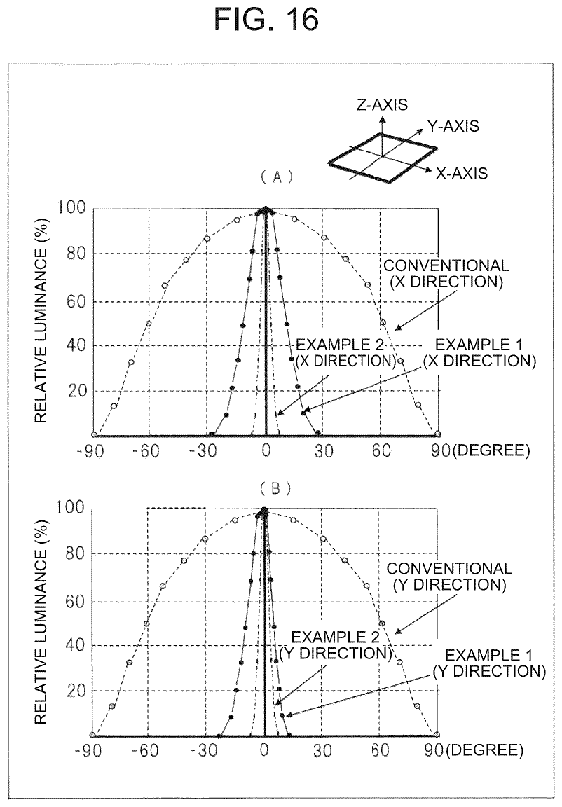

As a result, the light from the LEDs is uniformed to the specific polarization (such as the P-polarized light) and enters the liquid crystal display panel 11, brightness modulation is performed according to the video signal, and the video is displayed on the panel surface. Similar to the above-described example, a plurality of the LEDs constituting the light source are illustrated (note that since FIG. 16 is a vertical cross section, only one of them is illustrated), they are mounted at predetermined positions with respect to the collimators 18. Each of the collimators 18 is made of, for example, translucent resin, such as acrylic, or a glass. The collimator 18 may have an outer peripheral surface having a conical convex shape obtained by rotating the parabolic cross-sectional surface. The collimator 18 may have a top having a concave portion (namely, a convex lens surface) forming a convex portion at the center and has a convex lens portion protruded outside (or may be a concave lens surface recessed inside) at the center of the planar portion. A paraboloidal surface forming the outer peripheral surface having the cone shape of the collimator 18 is set within a range of angles at which the lights emitted from the LEDs in a peripheral direction can be totally reflected by the inside, or a reflecting surface is formed.

The respective LEDs are disposed at predetermined positions on the surface of the LED substrate 102 as the circuit board thereof. The LED substrate 102 is fixed such that each of the LEDs on the surface is disposed at a position of the center of the top having the conical convex shape of the collimator 18 (the concave portion thereof when the top has the concave portion).

With the configuration, in the light radiated from the LEDs, especially the light radiated from the central portion is condensed by the convex lens surfaces forming the outer shape of the collimators 18 and becomes parallel light by the collimators 18. The lights emitted from the other parts toward the peripheral direction is reflected by the paraboloidal surface forming the outer peripheral surface having the cone shape of the collimator 18 and is similarly condensed to be parallel light. In other words, with the collimators 18 constituting the convex lens at the center and forming the paraboloidal surface at the peripheral portion, almost all of the light generated by the LEDs can be taken out as the parallel light and the usage efficiency of the generated light can be improved.

The above-described configuration is a configuration similar to the light source apparatus of the video display apparatus illustrated in FIG. 12, FIG. 13, and the like. Further, the light converted into the approximately parallel light by the collimator 18 illustrated in FIG. 11 is reflected by the reflection type light guiding body 304. In the light, the light of the specific polarization passes through the reflective polarizing plate 49 by the action of the reflective polarizing plate 49 and the light of the other polarization reflected by the action of the reflective polarizing plate 49 passes through the light guiding body 304 again. The light is reflected by the reflective plate 271 at a position opposite to the liquid crystal display panel 11 with respect to the reflection type light guiding body 304. At this time, a polarization conversion is performed by the light passing through the λ/4 plate 270 as the phase difference plate twice. The light reflected by the reflective plate 271 passes through the light guiding body 304 again and enters the reflective polarizing plate 49 disposed on the opposite surface. Since the polarization conversion has been performed on the incident light, the incident light passes through the reflective polarizing plate 49 and enters the liquid crystal display panel 11 with the polarization directions uniformed. As a result, since all light of the light sources can be used, geometric usage efficiency of the light doubles. Additionally, since a degree of polarization of the reflective polarizing plate (extinction ratio) is multiplied by the extinction ratio of the entire system, the use of the light source apparatus of this embodiment substantially improves the contrast ratio as the entire display apparatus. Adjusting the surface roughness of the reflecting surface of the reflection type light guiding body 304 and the surface roughness of the reflective plate 271 allows adjusting a reflection diffusion angle of the light at each of the reflecting surfaces. It is only necessary to adjust the surface roughness of the reflecting surface of the reflection type light guiding body 304 and the surface roughness of the reflective plate 271 for each design such that the uniformity of the light entering the liquid crystal display panel 11 becomes more preferred.

Note that the λ/4 plate 270 as the phase difference plate in FIG. 11 is not necessarily required to have a phase difference of λ/4, the phase difference being with respect to the polarized light that has perpendicularly entered the λ/4 plate 270. In the configuration of FIG. 11, the phase difference plate only needs to change the phase by 90° (λ/2) by the polarized light passing through twice. The thickness of the phase difference plate only needs to be adjusted according to an incidence angle distribution of the polarized light.

Emitted light from the liquid crystal display panel 11 has similar diffusion characteristics in both of a screen horizontal direction (displayed as an X-axis in FIG. 16A) and a screen perpendicular direction (displayed as a Y-axis in FIG. 16B) in the conventional TV set. In contrast to this, for example, as illustrated in the example 1 in FIG. 16, in the diffusion characteristics of the light flux emitted from the liquid crystal display panel 11 of this embodiment, by setting the viewing angle at which the luminance becomes 50 of the front view (the angle: 0 degrees) to be 13 degrees, the viewing angle becomes ⅕ with respect to 62 degrees of the conventional viewing angle. Similarly, the viewing angles in the perpendicular direction are set to be non-uniform between up and down, and the reflection angle of the reflection type light guiding body, the area of the reflecting surface, and the like are optimized such that the viewing angle at the upper side is suppressed to be around ⅓ with respect to the viewing angle at the lower side. Consequently, compared with the conventional liquid crystal TV, an amount of video light heading for a monitoring direction is substantially improved, and the luminance becomes 50 times or more.

Further, with the use of the viewing angle characteristics illustrated in the example 2 in FIG. 16, by setting the viewing angle at which the luminance becomes 50% of the front view (the angle: 0 degrees) to be 5 degrees, the viewing angle becomes 1/12 with respect to 62 degrees of the conventional viewing angle. Similarly, the viewing angles in the perpendicular direction are set to be uniform between up and down, and the reflection angle of the reflection type light guiding body, the area of the reflecting surface, and the like are optimized such that the viewing angle is suppressed to be around 1/12 with respect to the conventional viewing angle. Consequently, compared with the conventional liquid crystal TV, an amount of video light heading for a monitoring direction is substantially improved, and the luminance becomes 100 times or more. As described above, configuring the viewing angle to be the narrow angle allows concentrating the amount of light flux heading for the monitoring direction, to thereby substantially improve the usage efficiency of the light. As a result, even when the conventional liquid crystal display panel for TV is used, by controlling the light diffusion characteristics of the light source apparatus, significant improvement in luminance can be achieved with similar power consumption, and the video display apparatus 1 corresponding to the air floating video display system for outdoor can be provided.

Returning to FIG. 11, as the basic configuration, as illustrated in FIG. 11, the light source apparatus causes the light flux having the narrow-angle directivity to enter the liquid crystal display panel 11, and modulates the luminance according to the video signal. Thus, video information displayed on the screen of the liquid crystal display panel 11 and the air floating video 3 obtained by being reflected by the retroreflector 2 are displayed outside a room or inside a room via the window glass 105.

### Example (1) of Light Source Apparatus 13

Subsequently, a configuration of an optical system, such as the light source apparatus, housed in the housing 106 (see FIG. 6B) will be described in detail with reference to FIG. 13A and FIG. 13B together with FIG. 12.

FIG. 12 illustrates the LED elements 14a, 14b constituting the light source, and they are mounted at predetermined positions with respect to LED collimators 15. Each of the LED collimators 15 is made of translucent resin, for example, acrylic. As illustrated in FIG. 13B as well, the LED collimator 15 has an outer peripheral surface 156 having a conical convex shape obtained by rotating the parabolic cross-sectional surface and has a top having a concave portion 153 forming a convex portion (namely, a convex lens surface) 157 at the center. The LED collimator 15 has a convex lens surface 154 protruded outside (or may be a concave lens surface recessed inside) at the center of the planar portion. A paraboloidal surface forming the outer peripheral surface 156 having the cone shape of the LED collimator 15 is set within a range of angles at which the lights emitted from the LED elements 14a, 14b in a peripheral direction can be totally reflected by the inside, or a reflecting surface is formed.

The respective LED elements 14a, 14b are disposed at predetermined positions on the surface of the LED substrate 102 as the circuit board thereof. The LED substrate 102 is fixed such that each of the LED elements 14a, 14b on the surface is disposed at a position of the center of the concave portion 153 with respect to the LED collimator 15.

With the configuration, in the light radiated from the LED element 14a or 14b, especially the light radiated upward from the central portion (the right direction of FIG. 13B) is condensed by two convex lens surfaces 157, 154 forming the outer shape of the LED collimators 15 and becomes parallel light by the above-described LED collimators 15. The lights emitted from the other parts toward the peripheral direction is reflected by the paraboloidal surface forming the outer peripheral surface 156 having the cone shape of the LED collimator 15 and is similarly condensed to be parallel light. In other words, with the LED collimators 15 constituting the convex lens at the centers and forming the paraboloidal surfaces at the peripheral portions, almost all of the light generated by the LED element 14a or 14b can be taken out as the parallel light and the usage efficiency of the generated light can be improved.

As illustrated in FIG. 13, a polarization conversion element 21 is disposed at the emission side of the light of the LED collimator 15. As apparent from FIG. 13, a plurality of the polarization conversion elements 21 are configured by combining pillar-shaped translucent members having a cross-sectional surface in a parallelogram (hereinafter, parallelogram columns) and pillar-shaped translucent members having a cross-sectional surface in a triangular shape (hereinafter, triangular columns), and the polarization conversion elements 21 are arrayed in an array shape in parallel to a surface perpendicular to the optical axes of the parallel light from the LED collimators 15. Further, polarizing beam splitters (hereinafter abbreviated as “PBS films”) 211 and reflective films 212 are alternately disposed in an interface between the adjacent translucent members arrayed in the array shape. A λ/2 phase plate 215 is disposed on the emission surface from which the light that has entered the polarization conversion element 21 and passed through the PBS film 211 is emitted.

Further, on the emission surface of the polarization conversion element 21, a synthetic diffusion block 16 having a rectangular shape also illustrated in FIG. 13A is disposed. That is, the light emitted from the LED element 14a or 14b becomes parallel light by the action of the LED collimator 15, enters the synthetic diffusion block 16 and after diffused by a texture 161 on the emission side, reaches a light guiding body 17.

The light guiding body 17 is, for example, a member formed in a rod shape having a cross-sectional surface in an approximately triangular shape (see FIG. 13B) made of translucent resin, such as acrylic. As apparent from FIG. 12, the light guiding body 17 includes a light guiding body light incident portion (surface) 171 opposed to the emission surface of the synthetic diffusion block 16 via a first diffusion plate 18a, a light guiding body light reflecting portion (surface) 172 forming an inclined surface, and a light guiding body light emission portion (surface) 173 opposed to the liquid crystal display panel 11 as the video display element via a second diffusion plate 18b.

In the light guiding body light reflecting portion (surface) 172 of the light guiding body 17, also as illustrated in FIG. 13B, which is a partially enlarged view thereof, many reflecting surfaces 172a and conjunction surfaces 172b are alternately formed in a serrated manner. The reflecting surface 172a (the line segment diagonally upward to the right in the drawing) forms an (n: a natural number and, for example, 1 to 130 in this example) with respect to a horizontal surface indicated by the one dot chain line in the drawing, and as one example, here, an is set to be 43 degrees or less (note that 0 degrees or more).

The light guiding body incident portion (surface) 171 is formed in a curved convex shape inclined to the light source side. According to this, the parallel light from the emission surface of the synthetic diffusion block 16 is diffused via the first diffusion plate 18a and enters, as apparent from FIG. 12, reaches the light guiding body light reflecting portion (surface) 172 while slightly bending (deflecting) upward by the light guiding body incident portion (surface) 171, is reflected here, and reaches the liquid crystal display panel 11 disposed on the emission surface on the upper side of FIG. 12.

The video display apparatus 1 describes in detail described above further improves light usage efficiency and the uniform illumination characteristics and it is possible to manufacture the compact and low-cost video display apparatus 1 including the light source apparatus of the modularized S-polarized light at the same time. In the above-described description, it has been described that the polarization conversion element 21 is mounted at the rear of the LED collimator 15, but the present invention is limited thereto, and the similar action and effect are obtained by disposing the polarization conversion element 21 in the optical path reaching the liquid crystal display panel 11.

In the light guiding body light reflecting portion (surface) 172, the many reflecting surfaces 172a and the many conjunction surfaces 172b are alternately formed in a serrated manner, and the illumination luminous flux is totally reflected by each of the reflecting surfaces 172a and heads for upward. Further, a narrow-angle diffusion plate (not illustrated) is disposed on the light guiding body light emission portion (surface) 173, the illumination luminous flux enters the light direction conversion panel 54 that controls the directional characteristics as the approximately parallel diffusion light flux and enters the liquid crystal display panel 11 in the oblique direction. In this embodiment, while the light direction conversion panel 54 is disposed between the light guiding body emission surface 9173 and the liquid crystal display panel 11, the similar effect is obtained by disposing it on the emission surface of the liquid crystal display panel 11.

### Example (2) of Light Source Apparatus 13

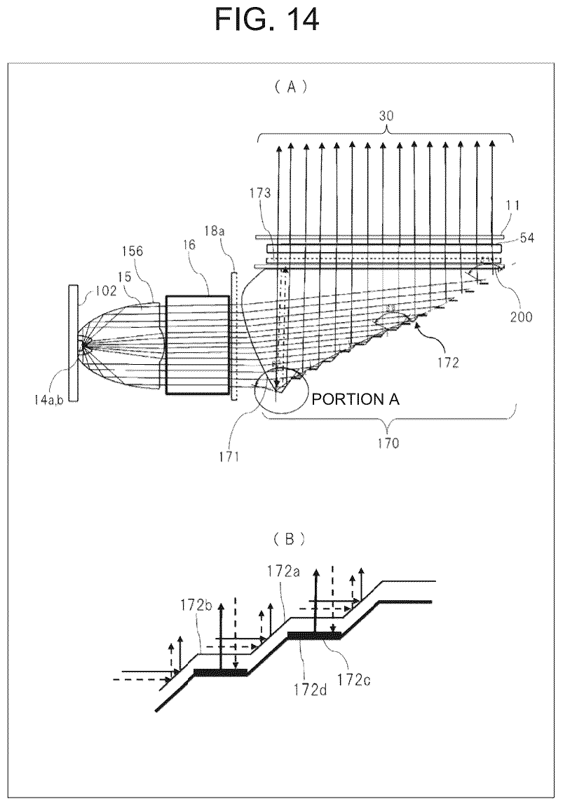

FIG. 14 illustrates another example of the configuration of the optical system, such as the light source apparatus 13. Similar to the example illustrated in FIG. 13, the plurality of (2 in this example) LED elements 14a, 14b constituting the light source are illustrated, and they are mounted at predetermined positions with respect to the LED collimators 15. Each of the LED collimators 15 is made of translucent resin, for example, acrylic. The LED collimator 15 has the outer peripheral surface 156 having a conical convex shape obtained by rotating the parabolic cross-sectional surface and has a top having the concave portion 153 forming the convex portion (namely, the convex lens surface) 157 at the center similar to the example illustrated in FIG. 13. The LED collimator 15 has the convex lens surface protruded outside (or may be the concave lens surface recessed inside) 154 at the center of the planar portion. A paraboloidal surface forming the outer peripheral surface 156 having the cone shape of the LED collimator 15 is set within a range of angles at which the light emitted from the LED element 14a in a peripheral direction can be totally reflected by the inside, or a reflecting surface is formed.

The respective LED elements 14a, 14b are disposed at predetermined positions on the surface of the LED substrate 102 as the circuit board thereof. The LED substrate 102 is fixed such that each of the LED elements 14a, 14b on the surface is disposed at a position of the center of the concave portion 153 with respect to the LED collimator 15.

With the above configuration, in the light radiated from the LED element 14a or 14b, especially the light radiated upward from the central portion (the right direction of the drawing) is condensed by the two convex lens surfaces 157, 154 forming the outer shape of the LED collimators 15 and becomes parallel light by the above-described LED collimators 15. The lights emitted from the other parts toward the peripheral direction is reflected by the paraboloidal surface forming the outer peripheral surface 156 having the cone shape of the LED collimator 15 and is similarly condensed to be parallel light. In other words, with the LED collimators 15 constituting the convex lens at the centers and forming the paraboloidal surfaces at the peripheral portions, almost all of the light generated by the LED element 14a or 14b can be taken out as the parallel light and the usage efficiency of the generated light can be improved.

A light guiding body 170 is disposed on the emission side of the light of the LED collimator 15 via the first diffusion plate 18a. The light guiding body 170 is, for example, a member formed in a rod shape having a cross-sectional surface in an approximately triangular shape (see FIG. 14A) made of translucent resin, such as acrylic. As apparent from FIG. 14A as well, the light guiding body 170 includes an incident portion (surface) 171 of the light guiding body 170 opposed to the emission surface of the synthetic diffusion block 16 via the first diffusion plate 18a, the light guiding body light reflecting portion (surface) 172 forming an inclined surface, and the light guiding body light emission portion (surface) 173 opposed to the liquid crystal display panel 11 as the video display element via a reflective polarizing plate 200.

When the reflective polarizing plate 200 having, for example, characteristics of causing the P-polarized light to be reflected (transmit the S-polarized light) is selected, the P-polarized light is reflected by the reflective polarizing plate 200 in natural lights emitted from the LED elements 14a, 14b as the light sources, passes through a λ/4 plate 172c disposed on the light guiding body light reflecting portion 172 illustrated in FIG. 14B, is reflected by a reflecting surface 172d, and again passes through the λ/4 plate 172c to be converted into the S-polarized light, and all of the light flux that enters the liquid crystal display panel 11 is unified to the S-polarized light.

Similarly, when the reflective polarizing plate 200 having characteristics of causing the S-polarized light to be reflected (transmit the P-polarized light) is selected, the S-polarized light is reflected by the reflective polarizing plate 200 in natural lights emitted from the LED elements 14a, 14b as the light sources, passes through the λ/4 plate 172c disposed on the light guiding body light reflecting portion 172 illustrated in FIG. 14B, is reflected by the reflecting surface 172d, and again passes through the λ/4 plate 172c to be converted into the P-polarized light, and all of the light flux that enters a liquid crystal display panel 52 is unified to the P-polarized light. The polarization conversion can be achieved also by the configuration described above.

### Example (3) of Light Source Apparatus 13

Another example of the configuration of the optical system, such as the light source apparatus, will be described with reference to FIG. 11. In the third example, as illustrated in FIG. 11, divergent light flux of natural light (P-polarized light and S-polarized light are mixed) from the LED substrate 102 is converted into approximately parallel light flux by the LED collimator lenses 18, and the approximately parallel light flux is reflected by the reflection type light guiding body 304 toward the liquid crystal display panel 11. The reflected light enters the reflective polarizing plate 49 disposed between the liquid crystal display panel 11 and the reflection type light guiding body 304. The specific polarization (such as S-polarization) is reflected by the reflective polarizing plate 49, passes through a surface connecting the reflecting surface of the light guiding body 304, and is reflected by the reflective plate 271 disposed facing the opposite surface of the light guiding body 304, a polarization conversion is performed by the specific polarization passing through the phase plate (the λ/4 wavelength plate) 270 twice, and the specific polarization passes through the light guiding body and the reflective polarizing plate, enters the liquid crystal display panel 11, and is modulated into video light. At this time, by matching the specific polarization with a polarization surface on which polarization conversion has been performed, the usage efficiency of light becomes double compared with the usual one, and the degree of polarization (the extinction ratio) of the reflective polarizing plate is multiplied by the extinction ratio of the entire system, and therefore the use of the light source apparatus of this embodiment considerably improves a contrast ratio of an information display system.

As a result, the natural light from the LEDs is uniformed to the specific polarization (such as P-polarization). Similar to the above-described example, a plurality of the LEDs constituting the light source are disposed (note that since FIG. 12 is a vertical cross section, only one of them is illustrated), they are mounted at predetermined positions with respect to the LED collimator lenses 18. Each of the LED collimator lenses 18 is made of, for example, translucent resin, such as acrylic, or a glass. The LED collimator lens 18 has an outer peripheral surface having a conical convex shape obtained by rotating the parabolic cross-sectional surface. The collimator 18 has a top having a concave portion forming a convex portion (namely, a convex lens surface) at the center. Further, at the center of the planar portion, a convex lens surface protruded outside (or may be a concave lens surface recessed inside) is provided. A paraboloidal surface forming the outer peripheral surface having the cone shape of the LED collimator lens 18 is set within a range of angles at which the lights emitted from the LED collimator lenses 18 in a peripheral direction can be totally reflected by the inside, or a reflecting surface is formed.

The respective LEDs are disposed at predetermined positions on the surface of the LED substrate 102 as the circuit board thereof. The LED substrate 102 is fixed such that each of the LEDs on the surface is disposed at a position of the center of the concave portion with respect to the LED collimator lens 18.

With the configuration, in the light radiated from the LEDs by the LED collimator lenses 18, especially the light radiated from the central portion is condensed by the two convex lens surfaces forming the outer shape of the LED collimator lens 18 and becomes parallel light. The lights emitted from the other parts toward the peripheral direction is reflected by the paraboloidal surface forming the outer peripheral surface having the cone shape of the LED collimator lens 18 and is similarly condensed to be parallel light. In other words, with the LED collimator lenses 18 constituting the convex lens at the center and forming the paraboloidal surface at the peripheral portion, almost all of the light generated by the LEDs can be taken out as the parallel light and the usage efficiency of the generated light can be improved.

### Example (4) of Video Display Apparatus

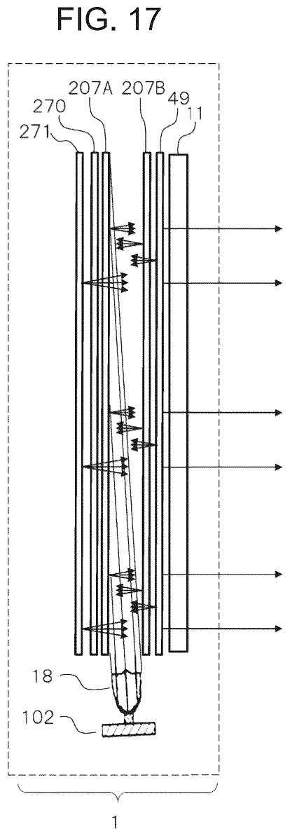

Furthermore, another example of the configuration of the optical system, such as the light source apparatus of the display apparatus (the example 4 of the display apparatus) will be described with reference to FIG. 17. The example is the exemplary configuration when a diffusion sheet is used instead of the reflection type light guiding body 304 in the light source apparatus of the example 3 of the display apparatus. Specifically, two optical sheets (an optical sheet 207A and an optical sheet 207B) that convert the diffusion characteristics in a perpendicular direction and a horizontal direction of the drawing (the front-rear direction of the drawing and not illustrated) are used on the emission side of light of the LED collimator lens 18, and the light from the LED collimator lens 18 is caused to enter between the two optical sheets (the diffusion sheets). The optical sheets may be one sheet, not two sheets. With one sheet, the perpendicular and horizontal diffusion characteristics are adjusted by a fine shape of the front surface and the back surface of one optical sheet. A plurality of diffusion sheets may be used to share actions. Here, in the example of FIG. 17, regarding the reflected diffusion characteristics by the front surface shape and the back surface shape of the optical sheet 207A and the optical sheet 207B, the number of LEDs, the divergence angle from the LED substrate (the optical element) 102, and optical specifications of the LED collimator lens 18 are preferably appropriately designed as design parameters such that surface densities of light flux emitted from the liquid crystal display panel 11 become uniform. That is, the diffusion characteristics are adjusted by the surface shapes of the plurality of diffusion sheets instead of the light guiding body. In the example of FIG. 17, the polarization conversion is performed by the method similar to the above-described example 3 of the display apparatus. That is, in the example of FIG. 17, it only necessary to provide characteristics such that the S-polarized light is reflected by the reflective polarizing plate 49 (the P-polarized light is transmitted). In the case, in the lights emitted from the LEDs as the light sources, the P-polarized light is transmitted, and the transmitted light enters the liquid crystal display panel 11. In the lights emitted from the LEDs as the light sources, the S-polarized light is reflected, and the reflected light passes through the phase difference plate 270 illustrated in FIG. 17. The light that has passed through the phase difference plate 270 is reflected by the reflective plate 271. The light reflected by the reflective plate 271 again passes through the phase difference plate 270 to be converted into the P-polarized light. The light on which polarization conversion has been performed passes through the reflective polarizing plate 49 and enters the liquid crystal display panel 11. The λ/4 plate 270 as the phase difference plate in FIG. 17 is not necessarily to have the phase difference of λ/4×, the phase difference being with respect to the polarized light that has perpendicularly entered the λ/4 plate 270. In the configuration of FIG. 17, the phase difference plate only needs to change the phase by 90° (λ/2) by the polarized light passing through twice. The thickness of the phase difference plate only needs to be adjusted according to an incidence angle distribution of the polarized light. In FIG. 17 as well, regarding polarization design according to the polarization conversion, the polarization may be configured reversely to the above-described description (the S-polarized light and the P-polarized light are reversed).

### Example (5) of Light Source Apparatus 13

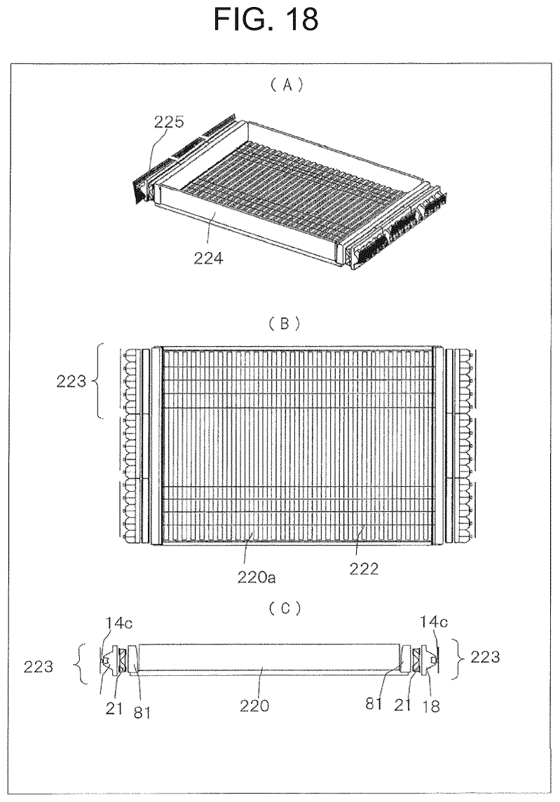

Another example of the configuration of the optical system of the light source apparatus 13 will be described with reference to FIG. 18. As illustrated in FIG. 18C, the polarization conversion element 21 is disposed on the emission side of the light of the LED collimator lens 18. The natural light from the LED elements 14c is uniformed to the specific polarization and is caused to enter optical elements 81 controlling the diffusion characteristics, and the diffusion characteristics in the perpendicular direction and the horizontal direction of the drawing (the front-rear direction of the drawing and not illustrated) are controlled to optimize light distribution characteristics toward the reflecting surface of a reflection type light guiding body 220. As illustrated in FIG. 18B, unevenness patterns 222 are disposed on the surface of the reflection type light guiding body 220, the light is reflected by the video display apparatus (not illustrated) disposed on the opposed surface of the reflection type light guiding body 220 to obtain the desired diffusion characteristics. Since the arrangement accuracy of the LED elements 14c and the LED collimator lenses 18 as the light sources significantly affects the efficiency of the light sources, usual optical axis accuracy needs to have accuracy of around 50 μm. Therefore, as a countermeasure against the decrease in mounting accuracy due to expansion of the LED collimator lens 18 by heat generation of the LED, the inventors used, for the light source apparatus, a plurality of or one unit as a structure of a light source unit 223 in which some of the LED elements 14c and the LED collimator lenses 18 are integrated, to thereby reduce the decrease in mounting accuracy.

In the embodiment illustrated in FIG. 18A, FIG. 18B, and FIG. 18C, the plurality of light source units 223 in which the LED elements 14c and the LED collimator lenses 18 are integrated are incorporated in both ends of the reflection type light guiding body 220 in the longitudinal direction (each of three pieces in the embodiment of FIG. 18) to achieve uniform luminance of the light source apparatus. The plurality of unevenness patterns 222 approximately parallel to the light source unit are formed on a reflecting surface 220a of the reflection type light guiding body 220. By forming a polyhedron on the surface of one unevenness pattern 222, the amount of light entering the video display apparatus 1 can be controlled with high accuracy. In this embodiment, although the shape of the reflecting surface is described as the unevenness patterns 222, it is needless to say that patterns of triangular surfaces, waveform surfaces, or the like are regularly or irregularly arrayed also fall within the scope of the invention of this application as long as the light distribution pattern toward the video display apparatus 1 from the reflection type light guiding body 220 is controlled by the surface shape. Additionally, to avoid the light controlled by the LED collimator lens 18 to leak to the outside from the light source apparatus 13, it is preferably designed that a light shielding wall 224 is disposed on the side surface of the reflection type light guiding body 220 and heat radiation performance of the LED elements 14c is enhanced by a metallic base 225.

<Lenticular Sheet>

The following will describe the action by the lenticular lens that controls the diffusion characteristics of the emitted light from the video display apparatus 1. Optimizing the lens shape of the lenticular lens allows the light emitted from the video display apparatus 1 as described above to pass through or be reflected by the window glass 105 to efficiently obtain the air floating video 3. That is, a sheet in which two lenticular lenses are combined or microlens arrays are disposed in a matrix and controls the diffusion characteristics of the video light from the video display apparatus 1 is provided, and the luminance of the video light (the relative luminance) can be controlled according to the reflection angle (0 degrees in the perpendicular direction) in the X-axis and Y-axis direction. In this embodiment, as illustrated in FIG. 16B, the lenticular lens allows making the luminance characteristics in the perpendicular direction steep compared with the conventional one. Further, by changing a balance of the directional characteristics in the up-down (the positive and negative directions of the Y-axis) direction, the luminance of light by reflection and diffusion (the relative luminance) can be enhanced. With the operational advantages, like the video light from the surface emission laser video source, it can be controlled that the video light has the narrow diffusion angle (high straightness) and only the specific polarization components, ghost images generated in the retroreflector when the video display apparatus according to the prior art is used are reduced, and the air floating video is efficiently reached to eyes of a watcher by retroreflection.

The above-described respective light source apparatuses can achieve the considerably narrow-angle directivity both in the X-axis direction and the Y-axis direction compared with the emitted light diffusion characteristics from the general liquid crystal display panel 11 (described as the prior art in the drawing) illustrated in FIG. 16A and FIG. 16B. This allows achieving the video display apparatus that emits the video light flux close to parallel to the specific direction and emits the light of the specific polarization.

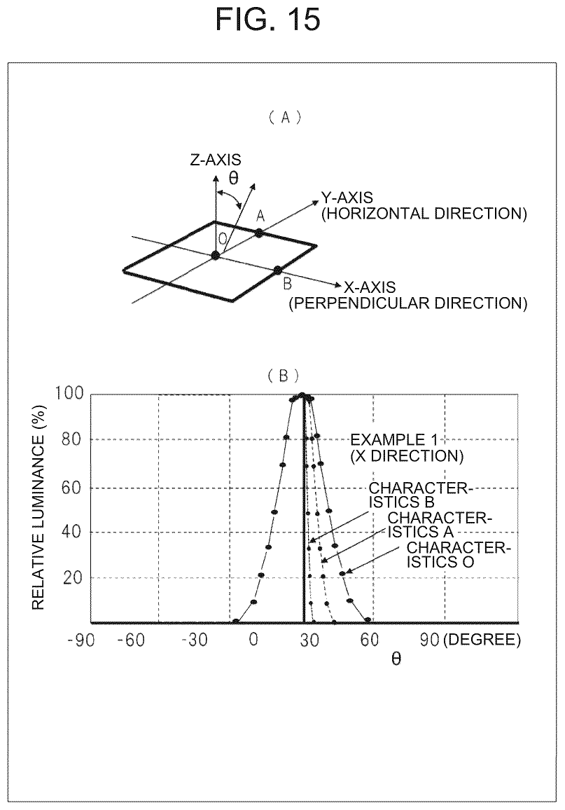

FIG. 15 illustrates an example of the characteristics of the lenticular lens employed in this embodiment. This example especially shows the characteristics in the X direction (the perpendicular direction), and characteristics O indicate that the peak of the emission direction of the light has an angle near 30 degrees upward from the perpendicular direction (0 degrees) and luminance characteristics are vertically symmetrical. Characteristics A and B in FIG. 15 show an example of the characteristics in which the video light above the peak luminance is further condensed at or near 30 degrees to enhance the luminance (the relative luminance). In view of this, in the characteristics A and B, at the angle in excess of 30 degrees, compared with the characteristic O, the luminance of the light (the relative luminance) is rapidly reduced.

That is, when the video light flux from the video display apparatus 1 is caused to enter the retroreflector 2, the optical system including the above described lenticular lens can control the emission angle and the viewing angle of the video light uniformed to have narrow angles by the light source apparatuses 13, 230 and the degree of freedom of installation of the retroreflector 2 is significantly improved. As a result, the degree of freedom of the relationship of the image forming position of the air floating video 3 that is reflected by or passes through the window glass 105 to form an image at the desired position can be significantly improved. This allows the light to be configured as light having the narrow diffusion angle (the high straightness) and containing only the specific polarization components and efficiently reach the eyes of the watcher outside or inside of a room. Accordingly, even when the intensity (the luminance) of the video light from the video display apparatus 1 is reduced, the watcher can accurately recognize the video light and obtain the information. In other words, by decreasing the output from the video display apparatus 1, the air floating video display system with low power consumption can be achieved.

Although various kinds of embodiments have been described in detail above, the present invention is not limited to be only the above-described embodiments and includes various modifications. For example, in the embodiments described above, the entire system has been described in detail for ease of understanding of the present invention and the present invention is not limited to one including all configurations described above. A part of a configuration of an embodiment can be replaced by a configuration of another embodiment or a configuration of another embodiment can be added to a configuration of an embodiment. Another configuration can be added to, removed from, or replaced by a part of a configuration of each embodiment.

In the technique according to the embodiments, displaying the air floating video by the video information with high resolution and high luminance in the air floating state allows, for example, an operation while the user does not feel anxious about contact infection of a communicable disease. The use of the technique according to the embodiment to the system used by a large indefinite number of users allows reducing a risk of contact infection of a communicable disease and providing a contactless user interface usable free from anxiety. This contributes to “3 Ensure healthy lives and promote well-being for all at all ages” in Sustainable Development Goals (SDGs) advocated by the United Nations.

In the technique according to the embodiments, by configuring the divergence angle of video light to be emitted to be small and further unfirming the video light so as to be the specific polarization, only the proper reflected light is efficiently reflected by the retroreflector. Therefore, usage efficiency of the light is high and the bright and clear air floating video can be obtained. The technique according to the embodiments allows providing the contactless user interface excellent in availability that can significantly reduce the power consumption. This contributes to “9 Build resilient infrastructure, promote inclusive and sustainable industrialization and foster innovation” and “11 Make cities and human settlements inclusive, safe, resilient and sustainable” in Sustainable Development Goals (SDGs) advocated by the United Nations.

Furthermore, the technique according to the embodiments allows forming the air floating video by the video light having high directionality (straightness). Even when a video for which high security is required in, for example, an ATM in a bank and a ticket-vending machine in a station and a video with high secrecy desired to be concealed from a person opposed to a user are displayed, the technique according to the embodiments allows providing a contactless user interface of small risk of a person other than the user peeking into the air floating video, by displaying the video light with high directionality. This contributes to “11 Make cities and human settlements inclusive, safe, resilient and sustainable” in Sustainable Development Goals (SDGs) advocated by the United Nations.

As described above, one configuration of this embodiment is an air floating video display apparatus for forming an air floating video that includes a display panel as a video source, a light source apparatus, and a retroreflector. The light source apparatus is configured to supply a light in a specific polarization direction to the display panel. The retroreflector includes a phase difference plate on a retroreflection surface. A polarization separation member is disposed in a space between the display panel and the retroreflector. The polarization separation member is configured to once transmit a video light of a specific polarization from the display panel to the retroreflector, perform polarization conversion by the retroreflector and convert the video light into a video light of another polarization to cause the video light to be reflected by the polarization separation member, and display the air floating video as a real image at a side opposite to the video source in a transparent member through which the video light of the specific polarization passes.

Additionally, one configuration of this embodiment is an air floating video display apparatus for forming an air floating video that includes a display panel as a video source, a light source apparatus, and a retroreflector. The light source apparatus is configured to supply a light in a specific polarization direction to the display panel. The retroreflector includes a phase difference plate on a retroreflection surface. A polarization separation member is disposed in a space between the display panel and the retroreflector. The polarization separation member is configured to once transmit a video light of a specific polarization from the display panel to the retroreflector, perform polarization conversion by the retroreflector and convert the video light into a video light of another polarization to cause the video light to be reflected by the polarization separation member, and display the air floating video as a real image at a side opposite to the video source in a transparent member disposed in an aperture through which the video light of the specific polarization passes. The retroreflector is disposed to be inclined with respect to the display panel and disposed at a position apart from the aperture through which retroreflection video light passes to hinder entrance of external light.

Additionally, one configuration of this embodiment is an air floating video display apparatus for forming an air floating video that includes a display panel, a light source apparatus, and a retroreflector. The light source apparatus is configured to supply a light in a specific polarization direction to the display panel. A light shielding member configured to block entrance of a video light flux having a divergence angle exceeding a specific angle from the display panel to the retroreflector is disposed in a space between the display panel and the retroreflector. A surface roughness of a reflecting surface of the retroreflector is set such that a proportion of an amount of blur l of the air floating video and a pixel size L of the display panel becomes 40% or less. The light source apparatus includes: a dotted or surface-shaped light source, an optical member configured to reduce a divergence angle of light from the light source; a polarization conversion member configured to uniform the light from the light sources to a polarized light in a specific direction; and a light guiding body having a reflecting surface for propagation to the display panel. The light guiding body is configured to adjust a divergence angle of reflected light by a shape and surface roughness of the reflecting surface disposed on the light guiding body. A video light flux having a narrow divergence angle from the display panel is reflected by the retroreflector to form the air floating video in midair.

Additionally, one configuration of this embodiment is an air floating video display apparatus for forming an air floating video that includes a display panel, a light source apparatus, and a retroreflector. The light source apparatus is configured to supply a light in a specific polarization direction to the display panel. A light shielding member configured to block entrance of a video light flux having a divergence angle exceeding a specific angle from the display panel to the retroreflector is disposed in a space between the display panel and the retroreflector. A surface roughness of a reflecting surface of the retroreflector is set such that a proportion of an amount of blur l of the air floating video and a pixel size L of the display panel becomes 40% or less. The light source apparatus includes: a dotted or surface-shaped light source; an optical member configured to reduce a divergence angle of light from the light source; a polarization conversion member configured to uniform the light from the light sources to a polarized light in a specific direction; and a light guiding body having a reflecting surface for propagation to the display panel. The light guiding body is disposed opposed to the display panel. A reflecting surface that causes the light from the light source to be reflected toward the display panel is disposed inside or on a surface of the light guiding body, and the reflecting surface causes the light in the specific polarization direction reflected by a reflective polarizing plate to pass through a surface connecting the adjacent reflecting surfaces of the light guiding body and be reflected by a reflective plate disposed at a surface opposite to a surface in contact with the display panel of the light guiding body, a polarization conversion is performed by causing the light to pass through a phase difference plate disposed on an upper surface of the reflective plate twice for conversion into a polarization passing through the reflective polarizing plate, and the light is caused to pass through the light guiding body to propagate the light to the display panel. The display panel modulates an optical intensity according to a video signal. The light source apparatus is configured to adjust a part of or all of divergence angles of video light flux that enters the display panel from the light source by a shape and surface roughness of a reflecting surface disposed on the light source apparatus. A video light flux having a narrow divergence angle from the display panel is caused to be reflected by the retroreflector to form the air floating video in midair.

Additionally, one configuration of this embodiment is an air floating video display apparatus for forming an air floating video that includes a display panel, a light source apparatus, and a retroreflector. The light source apparatus configured to supply a light in a specific polarization direction to the display panel. A light shielding member which is configured to block entrance of a video light flux having a divergence angle exceeding a specific angle from the display panel to the retroreflector is disposed in a space between the display panel and the retroreflector. A surface roughness of a reflecting surface of the retroreflector is set such that a proportion of an amount of blur l of the air floating video and a pixel size L of the display panel becomes 40% or less. The light source apparatus includes: a dotted or surface-shaped light source; an optical member configured to reduce a divergence angle of light from the light source; a light guiding body having a reflecting surface by which the light from the light source is reflected and that propagates the light to the display panel; and a phase difference plate and a reflecting surface opposed to the other surface of the light guiding body and disposed in an order from the light guiding body. The reflecting surface of the light guiding body is disposed to cause the light from the light source to be reflected and propagate the light to the display panel disposed opposed to the light guiding body. A reflective polarizing plate is disposed between the reflecting surface of the light guiding body and the display panel. A polarization conversion is performed by causing the light in the specific polarization direction reflected by the reflective polarizing plate to be reflected by a reflecting surface disposed opposed to and close to the other surface of the light guiding body and pass through the phase difference plate disposed between the light guiding body and the reflecting surface twice, and the light is caused to pass through the reflective polarizing plate to propagate the light in the specific polarization direction to the display panel. The display panel modulates an optical intensity according to a video signal. The light source apparatus is configured to control a part of or all of divergence angles of light flux entering the display panel from the light source by a shape and surface roughness of a reflecting surface disposed on the light source apparatus. A video light flux having a narrow divergence angle from the liquid crystal display panel is reflected by the retroreflector to form the air floating video in midair.

Additionally, in one configuration of this embodiment is, in the light source apparatus used for the air floating video display apparatus, the divergence angle is within ±30 degrees.

Additionally, one configuration of this embodiment is an air floating video display apparatus for forming an air floating video that includes a display panel, a light source apparatus, and a retroreflector. The light source apparatus is configured to supply a light in a specific polarization direction to the display panel. The light source apparatus includes: a dotted or surface-shaped light source; an optical member configured to reduce a divergence angle of light from the light source; a polarization conversion member configured to uniform the light from the light sources to a polarized light in a specific direction; and a light guiding body having a reflecting surface for propagation to the display panel. The light guiding body is disposed to be opposed to the display panel. A reflecting surface configured to cause the light from the light source to be reflected toward the display panel is disposed inside or on a surface of the light guiding body to propagate the light to the display panel. The light guiding body is configured to modulate an optical intensity according to a video signal by the display panel and adjust a part of or all of divergence angles of video light flux entering the display panel from the light source by a shape and surface roughness of the reflecting surface disposed on the light guiding body. The retroreflector is configured to cause a video light flux having a narrow divergence angle from the display panel to be reflected to form a floating video in midair. A shape of the retroreflector is formed in a concave surface or a convex surface with respect to the display panel having a curvature radius of 200 mm or more.

Additionally, one configuration of this embodiment is an air floating video display apparatus for forming an air floating video that includes a display panel, a light source apparatus, a transmissive plate, an optical system, a housing, and an outer frame. The light source apparatus is configured to supply a light in a specific polarization direction to the display panel. The transmissive plate includes a polarization separation member on a surface. The optical system includes a retroreflector. The housing is configured to house the display panel, the light source apparatus, the transmissive plate, and the optical system. The outer frame holds the transmissive plate and is coupled to the housing. A video light of a specific polarization from the display panel is reflected by the polarization separation member and a polarization conversion is performed on the video light on which retroreflection is performed by a phase difference plate disposed on the retroreflector, and the video light is caused to pass through the polarization separation member and the transmissive plate to form the air floating video. The optical system is disposed in the housing such that a part of or all of the air floating video is caught by a part of or all of the outer frame when a watcher of the air floating video watches the air floating video.

### DESCRIPTION OF REFERENCE SIGNS

1: Video display apparatus
1a: Video display
1b: Video controller
1c: Video signal receiver
1d: Reception antenna
2: Retroreflector
2a: Retroreflection portion
3: Air floating video
11: Liquid crystal display panel
12: Absorptive polarizing plate
13: Light source apparatus
13a: Light source apparatus
14a to c: LED element
15: LED collimator
16: Synthetic diffusion block
17: Light guiding body
18: LED collimator lens
18a: First diffusion plate
18b: Second diffusion plate
21: λ/4 plate (polarization conversion element)
22: First light shielding member
23: Second light shielding member
24: Third light shielding member
25: Fourth light shielding member
30: Arrow
49: Reflective polarizing plate
50: Protective cover
52: Liquid crystal display panel
54: Light direction conversion panel
81: Optical element
100: Transparent member
100a: Window portion
100b: Light shielding member
101: Polarization separation member
102: LED substrate
103: Heat sink
105: Window glass
106: Housing
107: Optical element
112: Absorptive polarizing plate
153: Concave portion
154: Convex lens surface
156: Outer peripheral surface
157: Convex lens surface
161: Texture
170: Light guiding body
172: Light guiding body light reflecting portion
172a: Reflecting surface
172b: Conjunction surface
172c: λ/4 plate
172d: Reflecting surface
173: Light guiding body light emission surface
200: Reflective polarizing plate
201: LED element
202: LED substrate
203: Light guiding body
203a: Reception light end surface
204: Light flux direction converting means
205: Reflection sheet
206: Reflective polarizing plate
207: Optical sheet
210: Natural light flux
211: PBS film
212: Reflective film
215: λ/2 phase plate
216: Phase difference plate
220: Reflection type light guiding body
220a: Reflecting surface
222: Unevenness pattern
223: Light source unit
224: Light shielding wall
225: Base
230: Light source apparatus
270: Phase difference plate
271: Reflective plate
272: Reflecting surface
304: Reflection type light guiding body
400: Reflective mirror
1027: Optical element polarization conversion element
2135: Two-phase plate
G1 to G6: First ghost image to sixth ghost image
R1: Proper image

1. An air floating video display apparatus for forming an air floating video, comprising:
a display panel as a video source;
a light source apparatus configured to supply a light in a specific polarization direction to the display panel; and
a retroreflector including a phase difference plate on a retroreflection surface, wherein
a polarization separation member is disposed in a space between the display panel and the retroreflector, and
the polarization separation member is configured to once transmit a video light of a specific polarization from the display panel to the retroreflector, perform polarization conversion by the retroreflector and convert the video light into a video light of another polarization to cause the video light to be reflected by the polarization separation member, and display the air floating video as a real image at a side opposite to the video source in a transparent member through which the video light of the specific polarization passes.

2. The air floating video display apparatus according to claim 1, wherein
the display panel has a video display surface disposed to be parallel to the retroreflection surface of the retroreflector.

3. The air floating video display apparatus according to claim 2, wherein
a display position of the air floating video is a position determined according to a distance between the display panel and the polarization separation member.

4. The air floating video display apparatus according to claim 1, wherein
the polarization separation member is formed of a reflective polarizing plate or a metal multilayer film by which the specific polarization is reflected.

5. The air floating video display apparatus according to claim 1, wherein
an absorptive polarizing plate is disposed on at least one surface of the transparent member.

6. The air floating video display apparatus according to claim 1, wherein
the transparent member includes that the part through which the video light passes of the transparent member is formed of a transparent body and the part through which the video light does not pass is formed of a light shielding member.

7. The air floating video display apparatus according to claim 1, wherein
an anti-reflection film is disposed on a video display surface of the display panel as the video source to absorb a reflected light by an absorptive polarizing plate disposed on the display panel.

8. An air floating video display apparatus for forming an air floating video, comprising:
a display panel as a video source;
a light source apparatus configured to supply a light in a specific polarization direction to the display panel; and
a retroreflector including a phase difference plate on a retroreflection surface, wherein
a polarization separation member is disposed in a space between the display panel and the retroreflector,
the polarization separation member is configured to once transmit a video light of a specific polarization from the display panel to the retroreflector, perform polarization conversion by the retroreflector and convert the video light into a video light of another polarization to cause the video light to be reflected by the polarization separation member, and display the air floating video as a real image at a side opposite to the video source in a transparent member disposed in an aperture through which the video light of the specific polarization passes, and
the retroreflector is disposed to be inclined with respect to the display panel and disposed at a position apart from the aperture through which a retroreflection video light passes to hinder entrance of external light.

9. The air floating video display apparatus according to claim 8, wherein
the light source apparatus is disposed at the position apart from the aperture through which the retroreflection video light passes or a position where the video light emitted from the display panel is not able to be visually perceived through the aperture.

10. The air floating video display apparatus according to claim 8, further comprising a reflective mirror by which an air floating video emitted from the aperture is once reflected, wherein
an angle of the reflective mirror is set to be a desired angle with respect to a plane of the aperture to allow changing a position and an angle of the obtained air floating video.

11. The air floating video display apparatus according to claim 8, further comprising a reflective mirror by which an air floating video emitted from the aperture is reflected, wherein
the reflective mirror has a characteristic of a high reflectivity of the specific polarization.

12. The air floating video display apparatus according to any-ene of claim 1, wherein
distortion of an image generated by an optical system forming the air floating video is corrected in a video displayed in the display panel as the video source.

13. An air floating video display apparatus for forming an air floating video, comprising:
a display panel;
a light source apparatus configured to supply a light in a specific polarization direction to the display panel; and
a retroreflector, wherein
a light shielding member configured to block entrance of a video light flux having a divergence angle exceeding a specific angle from the display panel to the retroreflector is disposed in a space between the display panel and the retroreflector,
a surface roughness of a reflecting surface of the retroreflector is set such that a proportion of an amount of blur l of the air floating video and a pixel size L of the display panel becomes 40% or less,
the light source apparatus includes:
a dotted or surface-shaped light source;
an optical member configured to reduce a divergence angle of a light from the light source;
a polarization conversion member configured to uniform the lights from the light sources to a polarized light in a specific direction; and
a light guiding body having a reflecting surface for propagation to the display panel,
the light guiding body is configured to adjust a divergence angle of a reflected light by a shape and surface roughness of the reflecting surface disposed on the light guiding body, and
a video light flux having a narrow divergence angle from the display panel is reflected by the retroreflector to form the air floating video in midair.

14. The air floating video display apparatus according to claim 13, wherein
the surface roughness of the reflecting surface of the retroreflector is set to be 160 nm or less,
the light guiding body is disposed to be opposed to the display panel, a reflecting surface that causes the light from the light source to be reflected toward the display panel is disposed inside or on a surface of the light guiding body to propagate the light to the display panel,
the display panel is configured to modulate an optical intensity according to a video signal, and
the video light flux having the narrow divergence angle from the display panel is reflected by the retroreflector to form the air floating video in midair.

15. The air floating video display apparatus according to claim 13, wherein
the light source apparatus is configured to adjust a part of or all of divergence angles of video light flux by a shape and surface roughness of the reflecting surface of the light source apparatus such that a light beam divergence angle of the display panel becomes within ±30 degrees.

16. The air floating video display apparatus according to claim 13, wherein
the light source apparatus is configured to adjust a part of or all of divergence angles of video light flux by a shape and surface roughness of the reflecting surface of the light source apparatus such that a light beam divergence angle of the display panel becomes within ±15 degrees.

17. The air floating video display apparatus according to claim 13, wherein
the light source apparatus is configured to adjust a part of or all of divergence angles of video light flux by a shape and surface roughness of the reflecting surface of the light guiding body such that light beam divergence angles of the display panel differ between a horizontal divergence angle and a perpendicular divergence angle.

18. The air floating video display apparatus according to claim 13, wherein
the light source apparatus has a contrast performance obtained by multiplying a contrast obtained by characteristics of polarizing plates disposed on a light incidence surface and a light emission surface of the display panel by an inverse of efficiency of polarization conversion in the polarization conversion member.

19. The air floating video display apparatus according to claim 13, wherein
the air floating video display apparatus is arranged such that a video light from the display panel is once reflected by a reflective polarizing plate and enters the retroreflector,
a phase difference plate is disposed on a video light incidence surface of the retroreflector, and
a polarization of the video light is converted into another polarization by the video light passing through the phase difference plate twice to cause the video light to pass through the reflective polarizing plate.

20. The air floating video display apparatus according to claim 19, wherein
the light source apparatus has a contrast performance obtained by multiplying a contrast obtained by characteristics of the polarizing plates disposed on the light incidence surface and a light emission surface of the display panel by each of an inverse of efficiency of polarization conversion in the polarization conversion member and an inverse of cross transmittance of the reflective polarizing plate.

21. An air floating video display apparatus for forming an air floating video, comprising:
a display panel;
a light source apparatus configured to supply a light in a specific polarization direction to the display panel; and
a retroreflector, wherein
a light shielding member configured to block entrance of a video light flux having a divergence angle exceeding a specific angle from the display panel to the retroreflector is disposed in a space between the display panel and the retroreflector,
a surface roughness of a reflecting surface of the retroreflector is set such that a proportion of an amount of blur l of the air floating video and a pixel size L of the display panel becomes 40% or less,
the light source apparatus includes:
a dotted or surface-shaped light source;
an optical member configured to reduce a divergence angle of light from the light source;
a polarization conversion member configured to uniform the light from the light sources to a polarized light in a specific direction; and
a light guiding body having a reflecting surface for propagation to the display panel,
the light guiding body is disposed opposed to the display panel,
a reflecting surface that causes the light from the light source to be reflected toward the display panel is disposed inside or on a surface of the light guiding body, and the reflecting surface causes the light in the specific polarization direction reflected by a reflective polarizing plate to pass through a surface connecting the adjacent reflecting surfaces of the light guiding body and be reflected by a reflective plate disposed at a surface opposite to a surface in contact with the display panel of the light guiding body, a polarization conversion is performed by causing the light to pass through a phase difference plate disposed on an upper surface of the reflective plate twice for conversion into a polarization passing through the reflective polarizing plate, and the light is caused to pass through the light guiding body to propagate the light to the display panel,
the display panel modulates an optical intensity according to a video signal,
the light source apparatus is configured to adjust a part of or all of divergence angles of video light flux that enters the display panel from the light source by a shape and surface roughness of a reflecting surface disposed on the light source apparatus, and
a video light flux having a narrow divergence angle from the display panel is caused to be reflected by the retroreflector to form the air floating video in midair.

22. An air floating video display apparatus for forming an air floating video, comprising:
a display panel;
a light source apparatus configured to supply a light in a specific polarization direction to the display panel; and
a retroreflector, wherein
a light shielding member configured to block entrance of a video light flux having a divergence angle exceeding a specific angle from the display panel to the retroreflector is disposed in a space between the display panel and the retroreflector,
a surface roughness of a reflecting surface of the retroreflector is set such that a proportion of an amount of blur l of the air floating video and a pixel size L of the display panel becomes 40% or less,
the light source apparatus includes:
a dotted or surface-shaped light source;
an optical member configured to reduce a divergence angle of light from the light source;
a light guiding body having a reflecting surface by which the light from the light source is reflected to propagates the light to the display panel; and
a phase difference plate and a reflecting surface opposed to the other surface of the light guiding body and disposed in an order from the light guiding body,
the reflecting surface of the light guiding body is disposed to cause the light from the light source to be reflected and propagate the light to the display panel disposed opposed to the light guiding body,
a reflective polarizing plate is disposed between the reflecting surface of the light guiding body and the display panel,
a polarization conversion is performed by causing the light in the specific polarization direction reflected by the reflective polarizing plate to be reflected by a reflecting surface disposed opposed to and close to the other surface of the light guiding body and pass through the phase difference plate disposed between the light guiding body and the reflecting surface twice, and the light is caused to pass through the reflective polarizing plate to propagate the light in the specific polarization direction to the display panel,
the display panel modulates an optical intensity according to a video signal,
the light source apparatus is configured to control a part of or all of divergence angles of light flux entering the display panel from the light source by a shape and surface roughness of a reflecting surface disposed on the light source apparatus, and
a video light flux having a narrow divergence angle from the display panel is reflected by the retroreflector to form the air floating video in midair.

23. The air floating video display apparatus according to claim 22, wherein
the light source apparatus is configured to adjust a part of or all of the divergence angles of the light flux by a shape and surface roughness of the reflecting surface disposed on the light source apparatus such that a light beam divergence angle of the display panel becomes within ±30 degrees.

24. The air floating video display apparatus according to claim 22, wherein
the light source apparatus is configured to adjust a part of or all of divergence angles of video light flux by a shape and surface roughness of the reflecting surface disposed on the light source apparatus such that a light beam divergence angle of the display panel becomes within ±10 degrees.

25. The air floating video display apparatus according to claim 22, wherein
the light source apparatus is configured to adjust a part of or all of divergence angles of video light flux by a shape and surface roughness of the reflecting surface disposed on the light source apparatus such that light beam divergence angles of the display panel differ between a horizontal divergence angle and a perpendicular divergence angle.

26. The air floating video display apparatus according to claim 22, wherein
the light source apparatus has a contrast performance obtained by multiplying a contrast obtained by characteristics of polarizing plates disposed on a light incidence surface and a light emission surface of the display panel by an inverse of cross transmittance of the reflective polarizing plate.

27. The air floating video display apparatus according to claim 22, comprising
two reflective polarizing plates, wherein
an arrangement is performed such that a video light flux from the display panel is once reflected by the reflective polarizing plate and enters the retroreflector,
a phase difference plate is disposed on a video light incidence surface of the retroreflector, and
a polarization of the video light is converted into another polarization by the video light passing through the phase difference plate twice to cause the video light to pass through the reflective polarizing plate.

28. The air floating video display apparatus according to claim 27, wherein
the light source apparatus has a contrast performance obtained by multiplying a contrast obtained by characteristics of polarizing plates disposed on a light incidence surface and a light emission surface of the display panel by respective inverses of cross transmittance of the two reflective polarizing plate.

29. The air floating video display apparatus according to claim 23, wherein
the light source apparatus includes a plurality of the light sources for one video display element.

30. The air floating video display apparatus according to claim 23, wherein
the light source apparatus includes a plurality of surface emission light sources having different emission directions of light for one video display element.

31. A light source apparatus used for the air floating video display apparatus according to claim 28, wherein
the divergence angle is within ±30 degrees.

32. The light source apparatus according to claim 31, wherein
the divergence angle is within ±10 degrees.

33. The light source apparatus according to claim 32, wherein
a horizontal diffusion angle differs from a perpendicular diffusion angle.

34. An air floating video display apparatus for forming an air floating video, comprising:
a display panel;
a light source apparatus configured to supply a light in a specific polarization direction to the display panel; and
a retroreflector, wherein
the light source apparatus includes:
a dotted or surface-shaped light source;
an optical member configured to reduce a divergence angle of light from the light source;
a polarization conversion member configured to uniform the light from the light sources to a polarized light in a specific direction; and
a light guiding body having a reflecting surface for propagation to the display panel,
the light guiding body is disposed to be opposed to the display panel,
a reflecting surface configured to cause the light from the light source to be reflected toward the display panel is disposed inside or on a surface of the light guiding body to propagate the light to the display panel,
the light guiding body is configured to modulate an optical intensity according to a video signal by the display panel and adjust a part of or all of divergence angles of video light flux entering the display panel from the light source by a shape and surface roughness of the reflecting surface disposed on the light guiding body,
the retroreflector is configured to cause a video light flux having a narrow divergence angle from the display panel to be reflected to form an air floating video in midair, and
a shape of the retroreflector is formed in a concave surface or a convex surface having a curvature radius of 200 mm or more with respect to the display panel.

35. The air floating video display apparatus for forming the air floating video according to claim 24, wherein
a shape of the retroreflector is formed in a concave surface or a convex surface having a curvature radius of 200 mm or more with respect to the display panel.

36. An air floating video display apparatus for forming an air floating video, comprising:
a display panel;
a light source apparatus configured to supply a light in a specific polarization direction to the display panel;
a transmissive plate including a polarization separation member on a surface;
an optical system including a retroreflector;
a housing configured to house the display panel, the light source apparatus, the transmissive plate, and the optical system; and
an outer frame that holds the transmissive plate and is coupled to the housing, wherein
a video light of a specific polarization from the display panel is reflected by the polarization separation member, and a polarization conversion is performed on the video light on which retroreflection is performed by a phase difference plate disposed on the retroreflector, and the video light is caused to pass through the polarization separation member and the transmissive plate to form the air floating video; and
the optical system is disposed in the housing such that a part of or all of the air floating video is caught by a part of or all of the outer frame when a watcher of the air floating video watches the air floating video.
